(19) United States
(12) Patent Application Publication
(10) Pub. No.: US 2026/0333175 A1
(43) Pub. Date: Oct. 22, 2026

(54) Methods and Apparatus for Supporting Handoff and/or Cell Reselection While Efficiently Using Uplink Capacity

(71) Applicant: Charter Communications Operating, LLC, St. Louis, MO (US)

(72) Inventor: Pareshkumar Panchal, Highlands Ranch, CO (US)

(21) Appl. No.: 19/184,967

(22) Filed: Apr. 21, 2025

(51) Int. Cl. H04W 36/32; H04W 36/00; H04W 36/08

(52) U.S. Cl. CPC H04W 36/322; H04W 36/0058; H04W 36/08

(57) ABSTRACT

A grid function, e.g., an artificial intelligence (AI) based grid function, creates a measurement/decision making grid based on UE measurements performed by UEs at different locations throughout a network wireless coverage area during a data collection time period. The created grid partitions a coverage area into grid tiles. Each grid tile corresponds to a different geographic area that is associated with a single preferred serving base station. Different grid tiles can have different preferred serving base stations. Information is stored for each grid tile. An analytics server, using the available stored grid information, and current UE device location information, identifies UE devices, for which it is desirable to handoff from one cell, e.g., base station, to another. The server triggers transition for a UE from one cell/base station to another based on UE location avoiding a need for signal strength measurements by the UE device immediately prior to the handoff.

### FIELD

The present application relates to communications methods and apparatus, and more particularly, to methods and apparatus supporting efficient handoff and/or cell reselection operations.

### BACKGROUND

In any service area or geography, typically multiple cells of the same network are present at a given point in time. Different sets of cells may be available to a user equipment (UE) at different locations as the UE moves throughout the coverage area of the network. The network has set thresholds for reporting available cells measurements such as, e.g., signal strength, signal quality, interference, etc. Frequent measuring and reporting of such measurements will occupy the uplink bandwidth, impact the device, e.g., user equipment (UE) device, battery life, and impact processing time at the base station. Often, this complexity and the amount of resources used regarding cell detection/reporting increases in a dense environment in which cells are overlapping with each other with dense penetration between the overlapping cells. Typically, as part of a handoff process of an active UE from one cell to another, the UE performs and reports a set of measurements corresponding to one or more available cells. This current approach, to a handoff, takes time, resources and battery power for implementing the measurement and reporting portion of the handoff process. The reporting of measurements made by a UE as part of an individual handoff decision making process requires uplink (UL) communications resources which could otherwise be used for communicating data and/or other information if such measurement information signaling could be limited and/or avoided every time a handoff was being contemplated.

Based on the above discussion, there is a need for new methods and apparatus, which will reduce the amount of resources, e.g., time, frequency, and/or power, being used for measuring, detecting, reporting and/or processing signals and/or information corresponding to available cells, which may be detected and/or used by a UE to facilitate handoff decisions and/or cell reselections.

### SUMMARY

Methods and apparatus supporting efficient handoff and/or cell reselection operations are described. An exemplary method, in accordance with the present invention, allows frequent UE measurements, used for identifying available cells at a particular location, to be skipped, while maintaining network quality and keeping elements of the existing decision making process intact. The exemplary method, in accordance with the present invention, will improve UE device battery life and effective network usage in the uplink by minimizing the amount of overhead needed for the measurements.

A grid information determination function uses artificial intelligence (AI) in some but not necessarily all embodiments to generate a measurement and/or decision making grid. In some embodiments an AI grid function, creates a grid, sometimes called “AI Grid”, based on UE measurements performed, e.g., during an initial limited measurement time interval or subsequent update process. The grid divides a communications coverage area into tiles with each tile corresponding to a different non-overlapping geographic area which is part the area in which communications service is provided.

The grid, sometimes referred to as an AI Grid, is partitioned into grid tiles. For each grid tile, a single preferred serving base station, identified by a corresponding PCI, is designated as a preferred cell, e.g., serving base station. Different grid tiles may have different preferred serving base stations or the same base station depending on the grid tiles relationship to a base station. The created AI grid is represented as a set of information which includes stored cell measurement information corresponding to different locations, e.g., different grid tiles. The information associated with a grid tile in the generated grid includes one, more or all of: the designated preferred serving base station corresponding to the grid tile, the PCI of the preferred serving base station, the geographic area corresponding to the grid tile, received measurement information, e.g., UE reported signal measurements, corresponding to the grid tile and/or other information such as other base stations which cover the grid tile area. The stored grid information, including the per grid tile information, is available to be used by an analytics server. The grid information facilitates and allows the analytics server to make handoff decisions for UEs, based on the stored historic measurement information and current UE device location information, without the need for current cell and/or signal measurements being performed by the UE as part of the handoff process.

In fact, UE handoff decisions and/or cell reselection for a UE can be and sometimes are made based on signal measurements and/or preferred base station information stored in the set of grid information that is based on signal measurements made by other UEs rather than the UE for which the decision is being made. In particular the preferred serving base station for a grid tile can be and sometimes is selected by the analytics server as a handoff target or cell re-selection target once the analytics server becomes aware of a UE's entry into a new/different grid tile area with a different preferred base station than the one being used by the UE at the time of entry into the new/different grid tile area.

In some embodiments, the created AI grid is updated on a periodic basis relatively infrequently, e.g., once a month, and/or a grid update is triggered in response to a detected event, reported events, alarms, and/or outages. In the case of periodic updates the update can be triggered by detection of an expiration of a timer. In the case of an alarm or outage the update can be triggered by the alarm or outage. For example, in some embodiments a detected base station outage will trigger a grid update while in other cases an alarm corresponding to an excessively high connection drop rate or handoff failure rate may trigger a grid update. As part of a grid update UEs will perform measurements and report the measurement results which are then used to update and/or create a set of grid information including preferred base station information for each tile area of the grid. Tile sizes can be and sometimes are altered as part of a grid update particularly in the case where a base station is added or removed causing a change in the coverage area of the individual operating base stations.

The analytics server, using the available stored AI grid information and current UE device location information, identifies UE devices, for which it is desirable to handoff from one cell to another with a cell handoff corresponding to a handoff from a serving base station to a target base station. The analytics server triggers transition for the UE from one cell to another without the need for cell availability related measurements and/or any processing of such measurement from the UE device side at the time of making a handoff ore cell reselection decision. In some embodiments, the analytics server will trigger and/or create transition preparation processes, e.g., based on current device location and detected device motion information, for an anticipated handover before a UE device moves into an area, e.g., a grid tile, in which a base station different from the UE's current serving base station is the preferred base station, e.g., cell, to improve decision making time and efficiency.

In some embodiments, an exemplary AI grid creation method, in accordance with an exemplary embodiment, includes: setting measurement parameters (e.g., Measurement status, Report Interval, report Amount, max Reported cells) to trigger measurements; capturing all the measurements during a time interval from each of the devices until all the coverage area has been completed with grid creation and in some cases, with associated time stamp information; disabling the measurements; and creating a grid, e.g., with 1 m, 5 m or 10 m resolution, where each grid tile in the grid has its own identify, serving cell, e.g., a preferred serving cell for the area corresponding to the grid tile, with a set of information, e.g. cell id, RSRP, RSRQ, SINR, etc.

In some embodiments, an exemplary decision making process, in accordance with an exemplary embodiment, includes: an analytics function monitoring and triggering cell reselection (idle mode) or handover (connected mode) decision appropriately as a device (UE) moves from one grid tile to another grid tile with the help of AI grid. Proactively, the source base station will trigger the handover to the target base station as per the feedback from the analytics function.

In some embodiments, at any given point in time, each of the devices (UEs) in a specific grid tile will be controlled to use the same serving cell, e.g., the preferred serving cell identified by the stored AI grid information for the specific grid tile, until it is forced by analytics to assign one or more UEs located within the grid tile to use another cell as their serving cell, due to the base station load or other network requirements.

An exemplary method of supporting communication using base stations, in accordance with some embodiments, comprises: storing grid information corresponding to a geographic area, said grid information including for each of a plurality of tiles of a grid corresponding to the geographic area one, more than one, all, or any possible combination of: i) tile size information, ii) tile location information and iii) preferred serving cell information; detecting movement of a first UE from a first grid tile area in which a first base station is a preferred base station to a second grid tile area, and iv) reported signal measurements and corresponding time stamps (e.g., indicating the time to which a signal measurement corresponds) corresponding to the tile area; determining from the stored grid information that a second base station, different from the first base station, is the preferred base station for the second grid tile; and initiating a handover from the first base station to the second base station in response to determining that the second base station is the preferred base station for the grid tile area into which the first UE has moved.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2 is a drawing which illustrates the exemplary communications system of FIG. 1 for an exemplary embodiment and further illustrates an exemplary portion of an AI created grid corresponding to the network wireless coverage area, in accordance with an exemplary embodiment.

FIG. 3 is a flowchart of an exemplary method of operating a communications system, e.g., the communications system of FIG. 1, in accordance with an exemplary embodiment.

FIG. 4 is a drawing illustrating a grid area portion including: i) grid tiles, in which BS A1 is the preferred serving base station, as indicated by left to right descending line shading; ii) grid tiles, in which BS B1 is the preferred serving base station, as indicated by dotted shading; and iii) grid tiles, in which BS C1 is the preferred serving base station, as indicated by left to right ascending line shading.

FIG. 5 is a drawing illustrating an exemplary known handover process.

FIG. 6 is a drawing illustrating an exemplary handover process in accordance with the present invention.

FIG. 7A is a first part of signaling diagram, illustrating an exemplary method of operating a communications system in accordance with an exemplary embodiment.

FIG. 7B is a second part of signaling diagram, illustrating an exemplary method of operating a communications system in accordance with an exemplary embodiment.

FIG. 7C is a third part of signaling diagram, illustrating an exemplary method of operating a communications system in accordance with an exemplary embodiment.

FIG. 7D is a fourth part of signaling diagram, illustrating an exemplary method of operating a communications system in accordance with an exemplary embodiment.

FIG. 7E is a fifth part of signaling diagram, illustrating an exemplary method of operating a communications system in accordance with an exemplary embodiment.

FIG. 7F is a sixth part of signaling diagram, illustrating an exemplary method of operating a communications system in accordance with an exemplary embodiment.

FIG. 7G is a seventh part of signaling diagram, illustrating an exemplary method of operating a communications system in accordance with an exemplary embodiment.

FIG. 7 comprises the combination of FIG. 7A, FIG. 7B, FIG. 7C, FIG. 7D, FIG. 7E, FIG. 7F and FIG. 7G.

FIG. 8 is a drawing of an exemplary analytics server in accordance with an exemplary embodiment.

FIG. 9 is a drawing of an exemplary artificial intelligence (AI) grid function in accordance with an exemplary embodiment.

FIG. 10 is a drawing of an exemplary element management system (EMS) including configuration management (CM) and fault management (FM) in accordance with an exemplary embodiment.

FIG. 11 is a drawing of an exemplary performance management system (PMS) in accordance with an exemplary embodiment.

FIG. 12 is a drawing of an exemplary base station, e.g., a gNB, in accordance with an exemplary embodiment.

FIG. 13 is a drawing of an exemplary user equipment (UE) in accordance with an exemplary embodiment.

### DETAILED DESCRIPTION

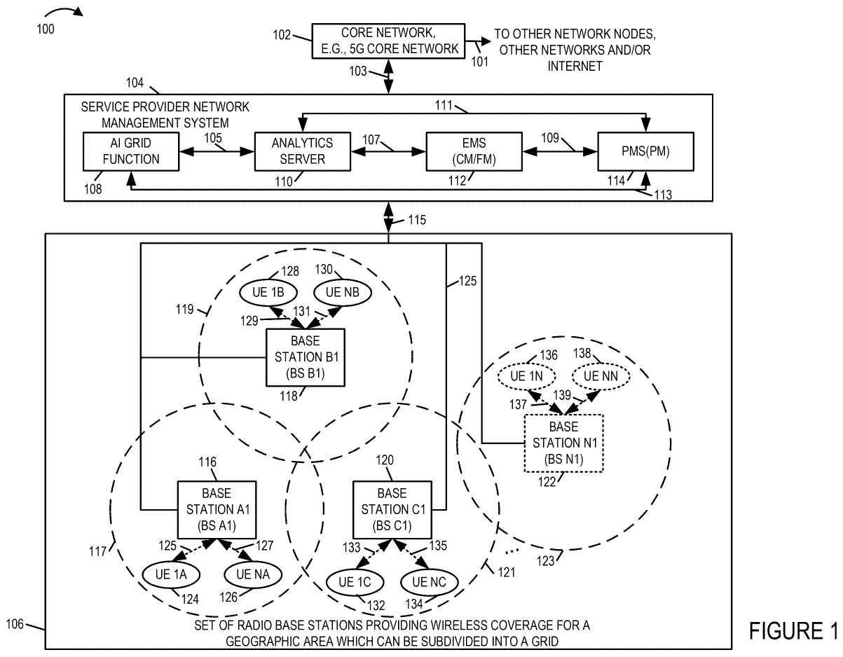

FIG. 1 is a drawing of an exemplary communications system 100 in accordance with an exemplary embodiment. Exemplary communications system 100 includes a core network 102, e.g., a 5G core network, a service provider network management system 104, and a set 106 of radio base stations providing wireless coverage for a geographic area which can be subdivided into a grid. The core network 102 is coupled to other network nodes, other networks and/or the Internet via communications link 101. Core network 102 is coupled to the service provider network management system 104 via communications link 103.

Service provider network management system 104 includes an artificial intelligence (AI) grid function 108, an analytics server 110, an element management system (EMS) 112, and a performance management system (PMS) 114 coupled together. AI grid function 108 is coupled to analytics server 110 via communications link 105. AI grid function 108 is coupled to PMS 114 via communications link 113. Analytics server 110 is coupled to EMS 112 via communications link 107. Analytics server 110 is coupled to PMS via communications link 111. EMS 112 is coupled to PMS 114 via communications link 109. The service provider network management system 104 is coupled to the set 106 of base stations (116, 118, 120, . . . , 122) via communication link 115. The base stations (116, 118, 120, . . . , 122) are coupled to one another via backhaul network 125. Base station N1 122 is optional and included in some, but not necessarily all embodiments.

The set 106 of base stations includes a plurality of base stations (base station A1 (BS A1) 116, base station B1 (BS B1) 118, base station C1 (BS C1) 120, . . . , base station N1 (BS N1) 122). Each of the base station (BS A1 116, BS B1 118, BS C1 120, . . . , BS N1 122) has a corresponding wireless coverage area (117, 119, 121, . . . , 123), respectively.

Exemplary communications system 100 further includes a plurality of user equipment devices (UE 1A 124, . . . , UE NA 126, UE 1B 128, . . . , UE NB 130, . . . , UE 1C 132, . . . , UE NC 134, . . . , UE 1N 136, . . . , UE NN 138); and at least some of the UEs are mobile wireless communications devices which may move throughout the system 100 and be at different locations at different times. In FIG. 1, UE 1A 124 and UE NA 126 are shown as being located within coverage area 117 and are coupled to BS A1 116 via wireless links 125, 127, respectively. In FIG. 1, UE 1B 128 and UE NB 130 are shown as being located within coverage area 119 and are coupled to BS B1 118 via wireless links 129, 131, respectively. In FIG. 1, UE 1C 132 and UE NC 134 are shown as being located within coverage area 121 and are coupled to BS C1 120 via wireless links 133, 135, respectively. In FIG. 1, UE 1N 136 and UE NN 138 are shown as being located within coverage area 123 and are coupled to BS N1 122 via wireless links 137, 139, respectively.

Core network 102, e.g., 5G core network, is a key part of the network, which establishes reliable connectivity for end users, e.g., UEs, and provides access to the network's services. The core domain handles a range of essential functions in the mobile network, such as connectivity and mobility management, authentication and authorization, subscriber data management and policy management. In some embodiments, core network functions are completely software based. The core network 102 can reside in an operator's private network infrastructure or in a cloud network for flexibility and higher agility support.

Connectivity, for an end user device, e.g., a UE, in the wireless communication will be handled by a radio base stations (116, 118 ,120, . . . , or 122), which can provide an air interface connection for an end user, e.g. a UE, to the wireless network.

Element management system (EMS) 112 includes configuration management (CM) functionality and fault management (FM) functionality. Each of the base stations (BS A1 116, BS B1 118, BS C1 120, . . . , BS N1 122) will be managed via EMS 112 for configuration and fault management purposes. Event monitoring, alarms, parameter modification, etc., will be managed through EMS 112 for the entire network.

The performance management system (PMS) 114 is a key component used to collect and store performance management (PM) and measurement information, e.g. in a PMS database/repository. In some embodiments, the PMS database/repository is included as part of the PMS 114. In other embodiments, the PMS database/repository is coupled to the PMS 114. The database includes, e.g., the history and records of each of the radio base stations (BS A1 116, BS B1 118, BS C1 120, . . . , BS N1 122) performance along with users such as, e.g., data rate, coverage, quality, connectivity, etc. in terms of statistics.

AI grid function 108 will be responsible for creating an updating an artificial intelligence based grid by taking and using the measurements from the PMS database/repository. In some embodiments, the AI grid function 108 is included as part of a server, e.g., an AI grid function server.

Analytics server 110 will be monitoring network events, configuration and alarms to keep updating the AI grid. The analytics server 110 will also be responsible for decision making of radio base stations handover function in a connection mode for a UE (from one cell to another cell), e.g., as the UE moves throughout the grid. In some embodiments, the analytics server 110 will also be responsible for making cell re-selection decisions for a UE (in idle mode). In some embodiments, the AI grid function is included as part of the analytics server 110.

UEs (124, 126, 128, 130, 132, 134, 136, 138) can be any type of devices such as, e.g., mobiles, tablets, laptops, watches, augmented reality (AR)/virtual reality (VR) headsets and/or other types of wireless devices, which can help access applications through wireless network connectivity, e.g., voice and/or data applications.

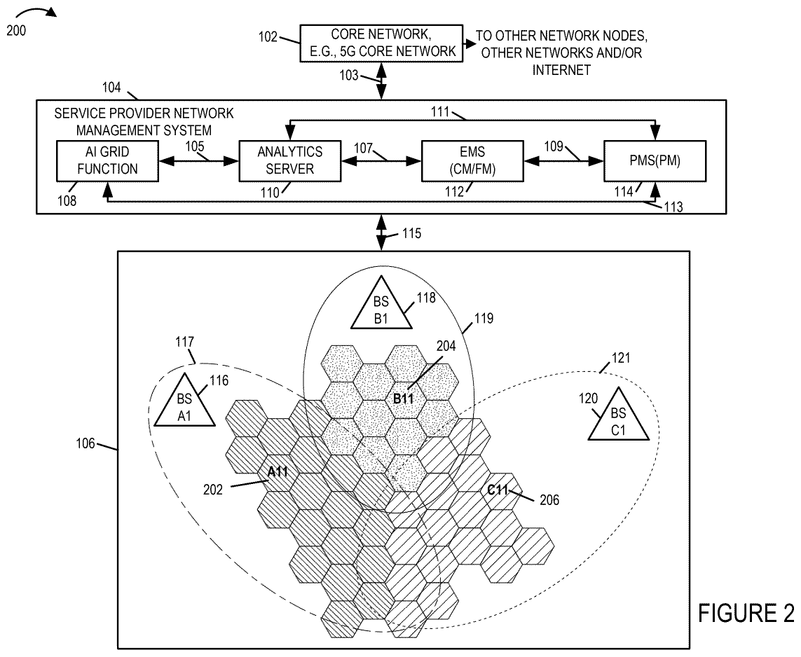

FIG. 2 is a drawing 200 which illustrates the exemplary communications system 100 for an exemplary embodiment, which includes base station A1 116, base station B1 118 and base station C1 120, and further illustrates an exemplary portion of an AI created grid corresponding to the network wireless coverage area, in accordance with an exemplary embodiment.

The AI created grid subdivides the network wireless coverage area into a plurality of grid tiles, each grid tile is associated with one of the base stations, which can provide wireless coverage for UEs located within the grid tile. The bae station associated with a grid tile is the preferred base station to be used by UEs located within the grid tile as the serving base station. In this example, grid tiles with left to right descending line shading, as exemplary grid tile A11 202 are associated with BS A1 116. In this example, grid tiles with dotted shading, as exemplary grid tile B11 204 are associated with BS B1 118. In this example, grid tiles with left to right ascending line shading, as exemplary grid tile C11 206 are associated with BS C1 120.

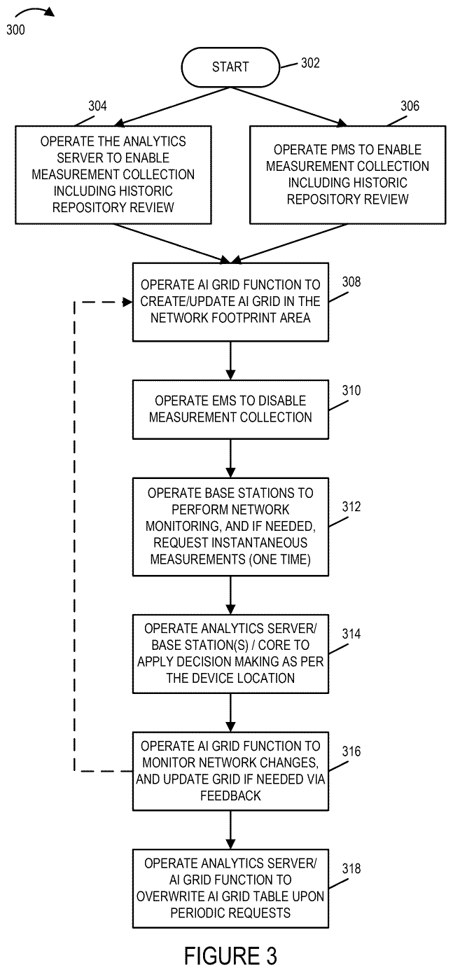

FIG. 3 is a flowchart 300 of an exemplary method of operating a communications system, e.g., communications system 100 of FIG. 1, in accordance with an exemplary embodiment. Operation starts in step 302, in which the communications system is powered on and initialized. Operation proceeds from start step 302 to steps 304 and 306.

In step 304 the analytics server, e.g., analytics server 110, is operated to enable measurement collection including historic repository review. Thus, the analytics server may notify the base stations in the system to command their UEs, e.g., serving UE to collect and report a set of information, e.g., information including, e.g., UE location and UE measurement information (e.g., RSRP, RSRQ, SINR, etc.) corresponding to detected cells. In step 306, the performance management system, e.g., PMS 114, is operated to enable measurement collection including historic repository review. Thus, in step 306, the PMS may receive and store measurement reports from UEs, said received measurement report information to be available to be used subsequently processed and used by the AI grid function. Operation proceeds from steps 304 and 306 to step 308.

In step 308, the AI grid function, e.g., AI grid function 108, is operated to create and/or update an AI grid in the network footprint area. For example, for a first iteration of step 308, the AI grid function is operated to create an AI grid corresponding to the wireless coverage area for the wireless network; and for subsequent iterations of step 308, the AI function is operated to update the existing AI grid. Operation proceeds from step 308 to step 310. In step 310 the element management system, e.g., EMS 112, is operated to disable measurement collection. Operation proceeds from step 310 to step 312.

In step 312 the base stations, e.g., base stations (BS A1 116, BS B1 118, BS C1 120, . . . , BS N1 122), are operated to perform network monitoring, and if needed request instantaneous measurements, e.g. one time, from a UE, e.g., to make a handoff decision. In general handoff decisions are made, e.g., under the direction of the analytics server using stored AI grid information (including information identifying a preferred serving base station (preferred serving cell) for each grid tile) without requiring a UE being handed off to perform and report measurement information corresponding to a set of alternative cells, which may be used to provide coverage. However, under some conditions, e.g., high loading at a preferred base station, instantaneous measurements may be, and sometimes are, requested, e.g., under the direction of the analytics server, and obtained from a UE being handed off, and the obtained information may be used, e.g., by the analytics server, in making a decision, e.g., as to a handoff target. Operation proceeds from step 312 to step 314.

In step 314 the analytics server, e.g., analytics server 110, base station(s), e.g. BS A1 116 and BS B1 118, and/or core, e.g., core 102, are operated to apply decision making as per the device location. For example, the analytics server may decide to trigger a handoff of a UE from a first base station to a second base, based on the analytics server, using stored AI grid information, and current UE location information, determining that the UE has moved from a first grid tile, in which BS 1A is the preferred serving base station to a second grid tile, in which BS 1B is the preferred serving base station. The analytics server sends a message to the first base station to trigger the handoff, and the first and second base station exchange handoff signals, e.g., with each other and/or with the UE being handed off and complete the handoff. As part of the handoff process, elements in the core may be affected, e.g., the AMF and/or UPF being used by the UE may be changed as part of the handoff process. Operation proceeds from step 314 to step 316.

In step 316 the AI grid function is operated to monitor for network changes and update the grid if needed via feedback. For example, the AI grid function may detect a network event, an alarm or an outage, and decide to update the AI grid, in which case operation proceeds from step 316 back to step 308. An AI grid update may correspond to the full wireless network coverage area or a portion of an affected portion of the wireless network coverage area, e.g., depending upon the situation. For example, if one base station (cell) goes down, only areas which have some overlap to the coverage area outage may be enabled and commanded to collect and report data to update a portion of the AI grid. In some embodiments, AI grid updates may be, and sometimes are initiated, in response to detected changes in reported KPIs from the base stations, e.g., above predetermined thresholds.

Operation proceeds from step 316 to step 318, in which the analytics server and/or AI grid function are operated to update a stored AI grid, e.g., overwrite the previously generated AI grid table, e.g., a stored historic AI grid table including AI grid table entries corresponding to each AI grid tile, upon periodic requests. In some embodiments, the entire AI grid is updated periodically, e.g. once a month. Thus, in some embodiments, the analytics server activates the measurement collection by the UEs and reporting of information corresponding to available cells for a time interval to allow the PMS, to acquire more current data to be used by the AI grid function to update, e.g., fine tune the AI grid.

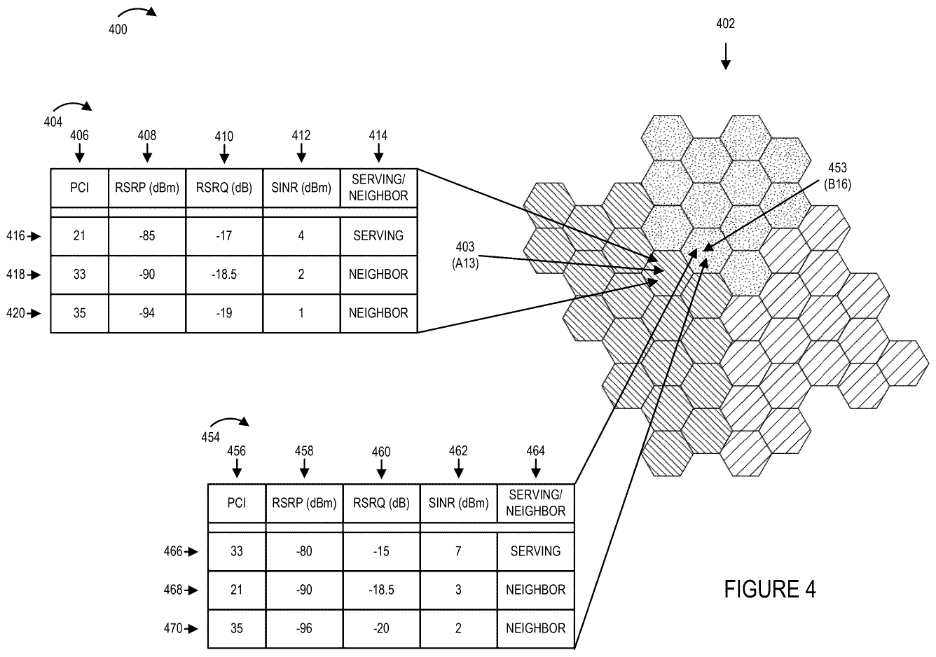

FIG. 4 is a drawing 400 illustrating a grid area portion 402 including: i) grid tiles, in which BS A1 is the preferred serving base station, as indicated by left to right descending line shading; ii) grid tiles, in which BS B1 is the preferred serving base station, as indicated by dotted shading; and iii) grid tiles, in which BS C1 is the preferred serving base station, as indicated by left to right ascending line shading. Each grid tile in the generated AI grid has a corresponding generated grid tile table, which is stored and utilized by the analytics server, e.g., in making handoff and/or cell re-selection decisions.

Table 404 corresponds to grid tile A13 403 and presents a set of information for the grid tile A13, said set of information based on processed UE measurements obtained at locations within grid tile A13 403 during a collection time interval. First column 406 indicates PCI, which identifies a particular radio base station (cell). Second column 408 includes RSRP values in units of dBm. Third column 410 includes RSRQ values in units of dB. Fourth column 412 includes SINR values in units of dBm. Fifth column 414 identifies the AI grid function determined preferred serving/neighbor cell status for each of the reported cells.

Row 416 indicates that the radio base station (cell) with PCI=21 has: i) a RSRP=−85 dBm, ii) a RSRQ=−17 dB, and iii) SINR=4 dBm, and is designated as the preferred serving cell for the grid tile A13 403. Row 418 indicates that the radio base station (cell) with PCI=33 has: i) a RSRP=−90 dBm, ii) a RSRQ=−18.5 dB, and iii) SINR=2 dBm, and is designated as a neighbor cell for the grid tile A13 403. Row 420 indicates that the radio base station (cell) with PCI=35 has: i) a RSRP=−90 dBm, ii) a RSRQ=−18.5 dB, and iii) SINR=2 dBm, and is designated as a neighbor cell for the grid tile A13 403.

Table 454 corresponds to grid tile B16 453 and presents a set of information for the grid tile B13, said set of information based on processed UE measurements obtained at locations within grid tile B16 453 during a collection time interval. First column 456 indicates PCI, which identifies a particular radio base station (cell). Second column 458 includes RSRP values in units of dBm. Third column 460 includes RSRQ values in units of dB. Fourth column 462 includes SINR values in units of dBm. Fifth column 464 identifies the AI grid function determined preferred serving/neighbor cell status for each of the reported cells.

Row 466 indicates that the radio base station (cell) with PCI=33 has: i) a RSRP=−80 dBm, ii) a RSRQ=−15 dB, and iii) SINR=7 dBm, and is designated as the preferred serving cell for the grid tile B16 453. Row 468 indicates that the radio base station (cell) with PCI=22 has: i) a RSRP=−90 dBm, ii) a RSRQ=−18.5 dB, and iii) SINR=3 dBm, and is designated as a neighbor cell for the grid tile B16 453. Row 470 indicates that the radio base station (cell) with PCI=35 has: i) a RSRP=−96 dBm, ii) a RSRQ=−20 dB, and iii) SINR=2 dBm, and is designated as a neighbor cell for the grid tile B16 453.

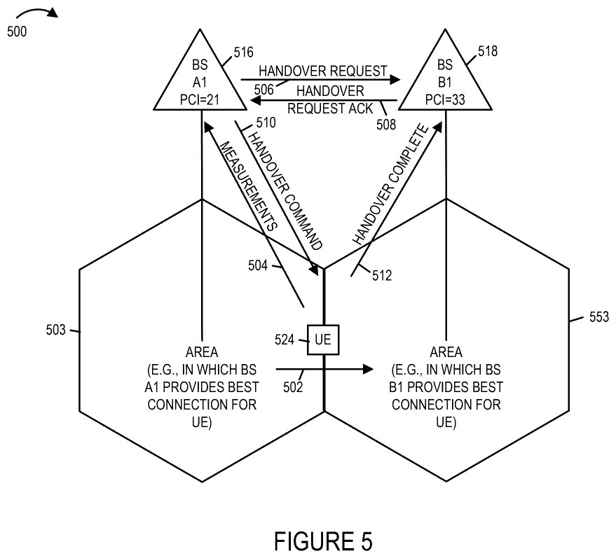

FIG. 5 is a drawing 500 illustrating an exemplary known handover process. Drawing 500 includes BS A1 516 with PCI=21, BS B1 518 with PCI=33, and UE 524. Consider that UE 524 is initially connected to BS A1 516, which is its serving base station. Further consider that UE is moving from area 503 to area 553, as indicated by arrow 502. In area 553 UE 524 receives signals, e.g., reference signals, from BS A1 516 and BS B1 518, performs measurements, e.g., obtaining RSRP, RSRQ, and SINR values for each of the base stations (cells), and generates a measurement report. UE 524 sends the measurement report 504 to BS A1 516. BS A1 516 evaluates the received measurement report, determines that UE 524 should be handed over to BS B1 518, e.g., because at the current location of UE 524, UE 524 would have a better connection if BS B1 518 was its serving base station, generates and sends handover request message 506 to BS B1 518. BS B1 518 receives the handover request 506, decides to allow the handover and sends a handover request ack 508 to BS A1 516. BS A1 508 receives the handover request ack 508, and in response, generates and sends a handover command message 510 to UE 524. UE 524 receives the handover command, performs operations to perform the handover from BS A1 516 to BS B1 518, and generates and sends a handover complete message to 512 to BS B1 518.

Note that in the known handover process of FIG. 5, UE 524 needs to perform monitoring of signals, e.g., reference signals, from possible alternative base stations (cells) which may be able to provide service to UE 524 at its location, measure and process the received signals, generate a measurement report, and sends the measurement report to its serving base station. This monitoring, detection, measurement, and reporting process is typically performed frequently, e.g., as UE 524 moves throughout the network to facilitate handover decisions, e.g., by the serving base station. This frequent monitoring, detection, measurement, and reporting process requires and uses both air link resources, e.g., UL air link resources, and UE battery power resources.

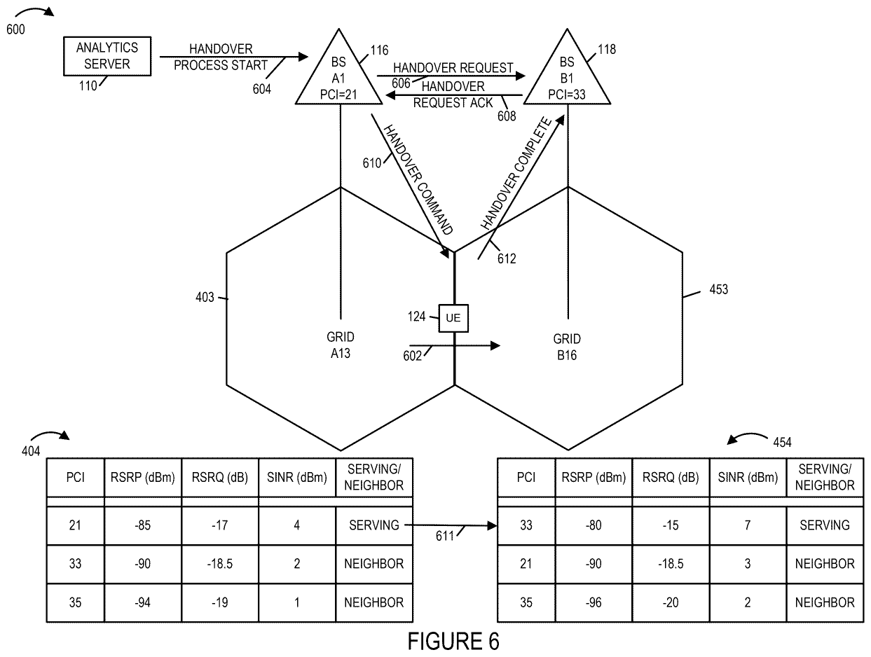

FIG. 6 is a drawing 600 illustrating an exemplary handover process in accordance with the present invention. Drawing 600 includes BS A1 116 with PCI=21, BS B1 188 with PCI=33, and UE 124. Consider that UE 124 is initially connected to BS A1 116, which is its serving base station. Further consider that UE 124 is moving from grid tile A13 403 to grid tile B16 453, as indicated by arrow 602.

Consider that AI grid function 106 has previously collected reports from UEs and has generated and stored an AI grid for the network wireless coverage area, which includes tables for each AI grid tile, and identifies a preferred serving wireless base station (cell) for each grid tile. The stored AI grid information includes table 404, which corresponds to grid tile A13 403 and table 454, which corresponds to grid tile B16 453.

The analytics server 110, which has access to UE 124 device location and/or device motion information, also has access to the stored AI grid information including tables 404 and 454. The analytics server 110, using the UE 124 current location information and the stored historic AI grid information, can, and sometimes does, makes handover decisions for UE 124 without requiring UE 124 to perform measurements of reference signals from potential serving base stations (cells) and sending measurements reports for evaluation immediately prior to the handover decision. Thus, the analytics server 110 relies on historic UE measurement information from the AI grid database, to identify the preferred serving base station for particular grid tiles and to make handover decisions.

Analytics server 110 determines that UE 124 should be handed over to BS B1 118, e.g., because BS B1 with PCI=33 is the preferred serving base station for grid tile B16 as identified by the information in table 454. Analytics server 110 generates and sends handover process start message 604 to BS A1 116 to trigger the handover of UE 124 from BS A1 116 to BS B1 118. BS B1 118 receives the handover request 606, decides to allow the handover and sends a handover request ack 608 to BS A1 616. BS A1 608 receives the handover request ack 608, and in response, generates and sends a handover command message 610 to UE 124. UE 124 receives the handover command, performs operations to perform the handover from BS A1 116 to BS B1 118, and generates and sends a handover complete message to 612 to BS B1 118.

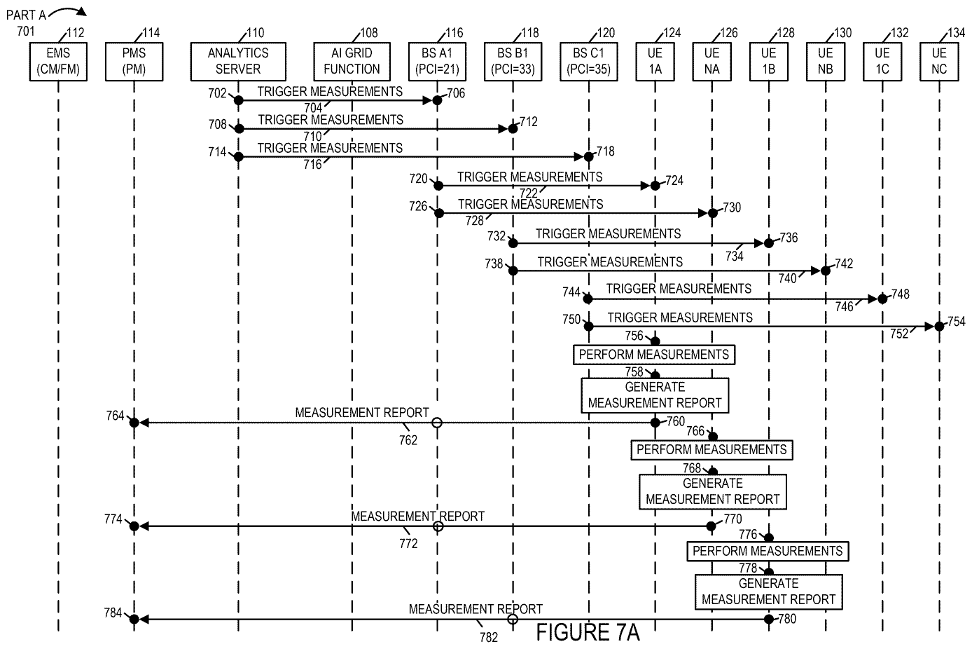

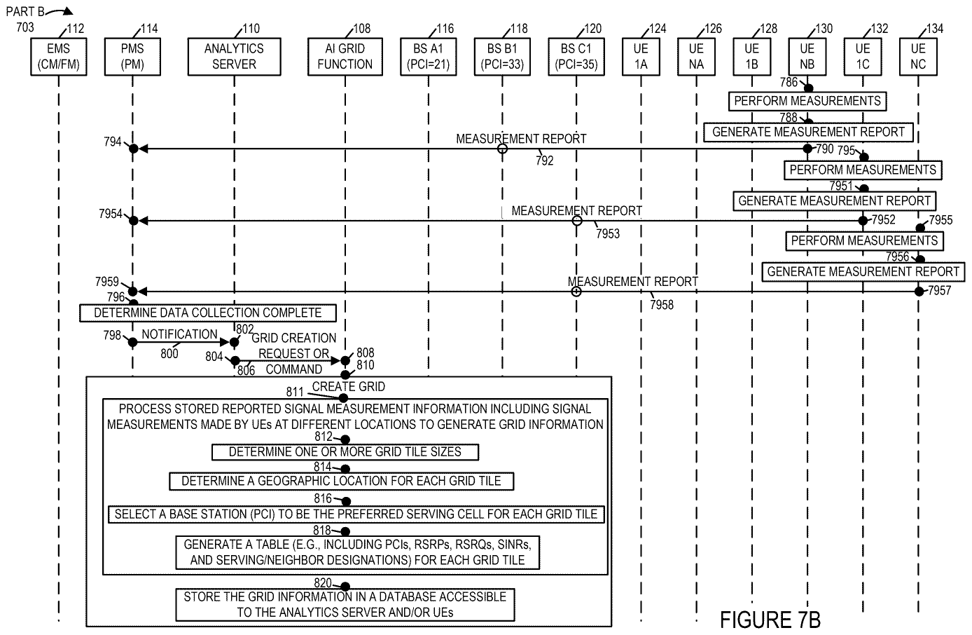

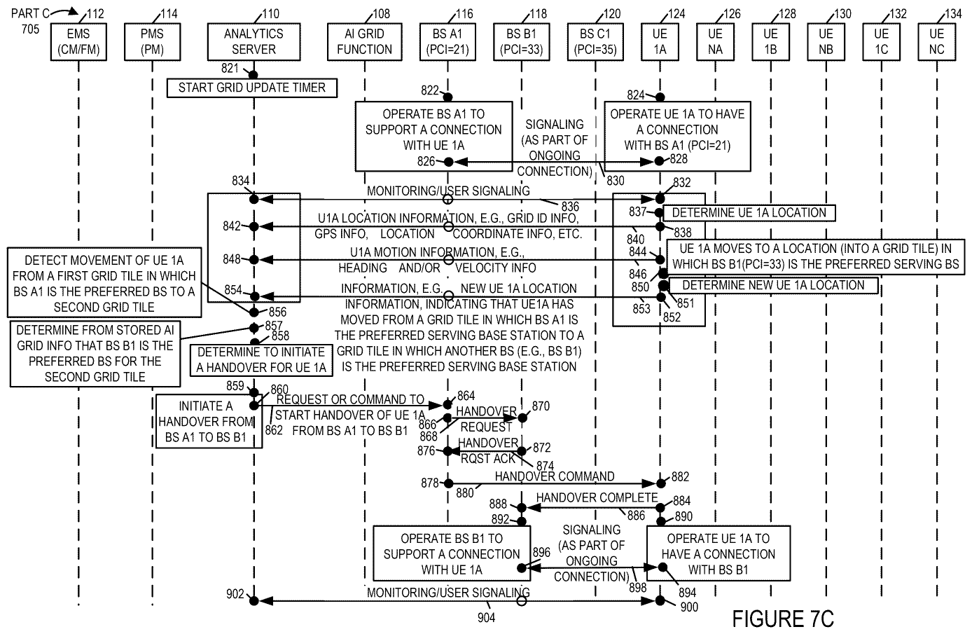

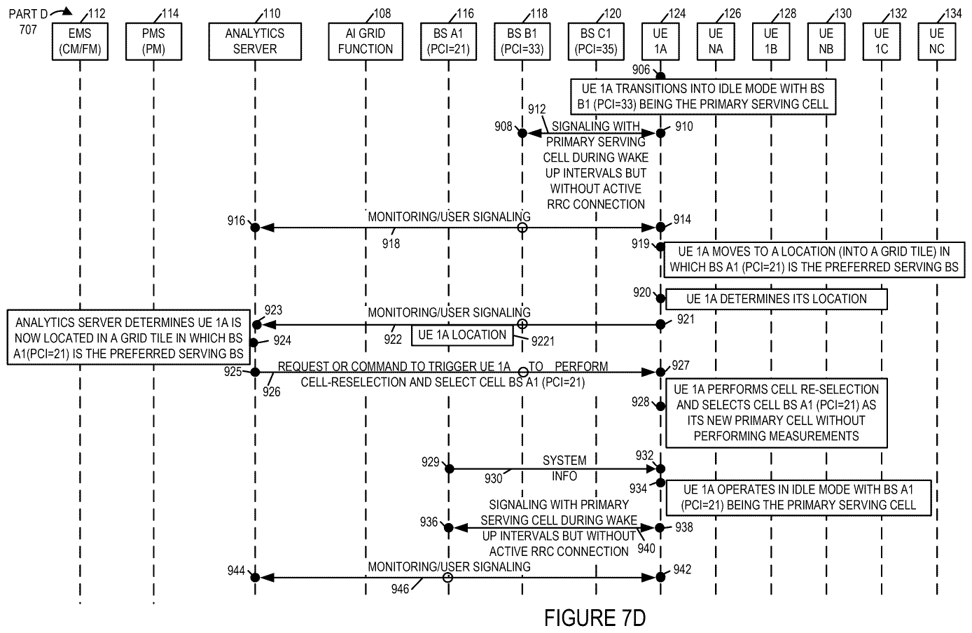

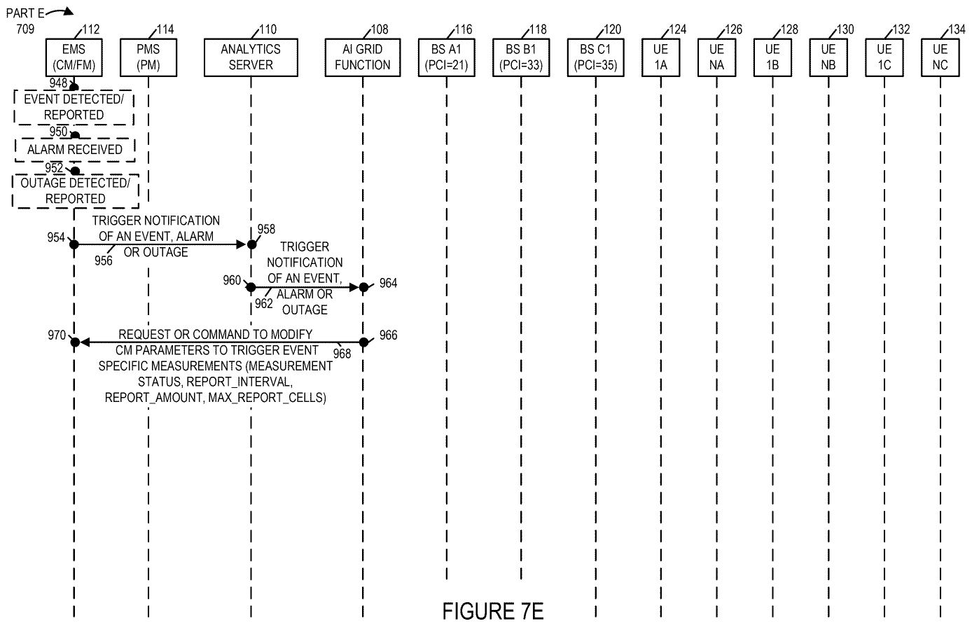

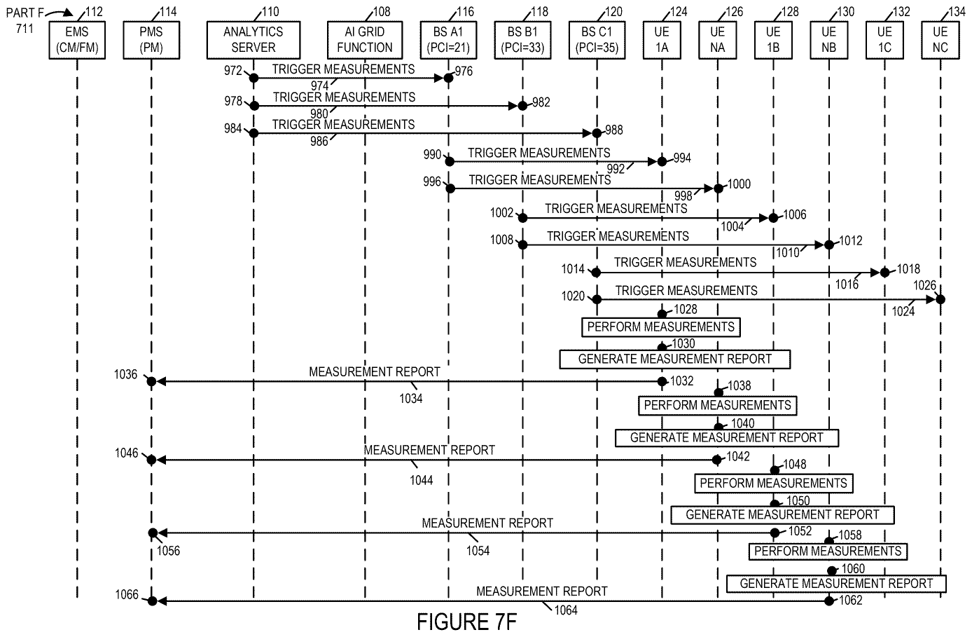

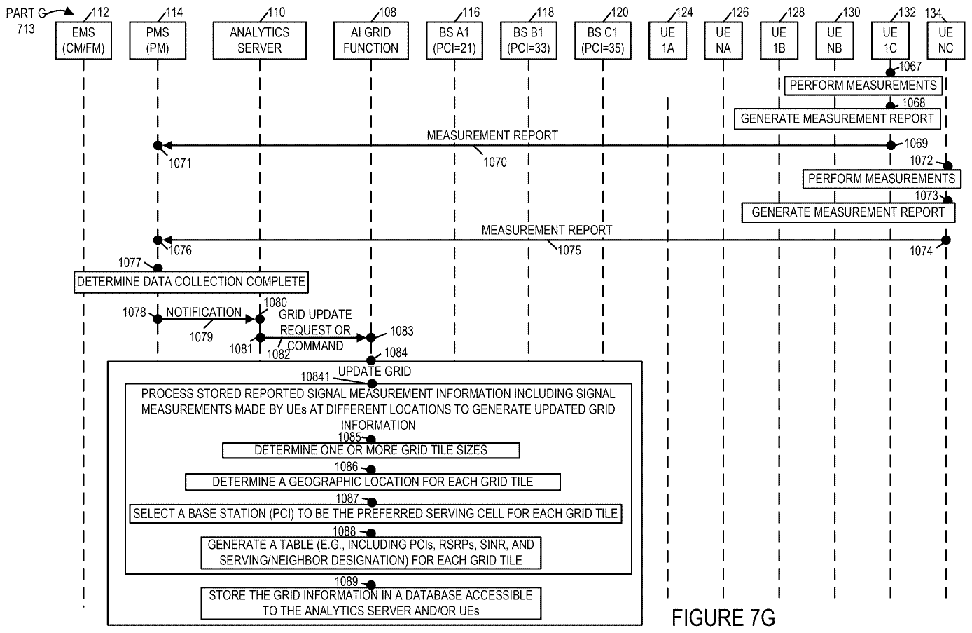

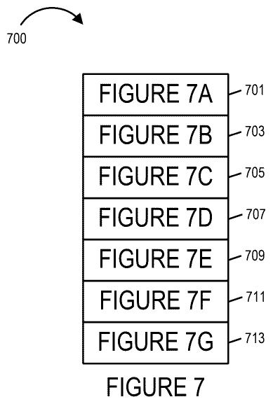

FIG. 7, comprising the combination of FIG. 7A, FIG. 7B, FIG. 7C, FIG. 7D, FIG. 7E, FIG. 7F and FIG. 7G, is a signaling diagram 700, comprising Part A 701, Part B 703, Part C 705, Part D 707, Part E 709, Part F 711 and Part G 713, of an exemplary method of operating a communications system, e.g., system 100 of FIG. 1, in accordance with an exemplary embodiment. The exemplary communications system, implementing the method of signaling diagram 700 includes EMS 112 including configuration management (CM) and fault management (FM) functionality, PMS 114 including performance management (PM) functionality and a database, analytics server 110, AI grid function 108 including an grid database, BS A1 116, BS B1 118, BS C1 120, UE 1A 124, UE NA 126, UE 1B 128, UE NB 130, UE 1C 132, UE NC 134.

In step 702 analytics server 110 generates and sends trigger measurements message 704 to BS A1 116, which is received by BS A1 116 in step 706. In step 708 analytics server 110 generates and sends trigger measurements message 710 to BS B1 118, which is received by BS B1 118 in step 712. In step 714 analytics server 110 generates and sends trigger measurements message 716 to BS C1 120, which is received by BS C1 120 in step 718.

In step 720 BS A1 116, in response to receiving message 704 in step 706, generates and transmits trigger measurements message 722 to UE 1A 124, which is received by UE 1A 124 in step 724. In step 726 BS A1 116, in response to receiving message 704 in step 706, generates and transmits trigger measurements message 728 to UE NA 126, which is received by UE NA 126 in step 730.

In step 732 BS B1 118, in response to receiving message 710 in step 712, generates and transmits trigger measurements message 734 to UE 1B 128, which is received by UE 1B 128 in step 736. In step 738 BS B1 118, in response to receiving message 710 in step 712, generates and transmits trigger measurements message 740 to UE NB 130, which is received by UE NB 130 in step 742.

In step 744 BS C1 120, in response to receiving message 716 in step 718, generates and transmits trigger measurements message 746 to UE 1C 132, which is received by UE 1C 132 in step 748. In step 750 BS C1 120, in response to receiving message 716 in step 718, generates and transmits trigger measurements message 752 to UE NC 134, which is received by UE NC 140 in step 754.

In step 756 UE 1A 124, in response to receiving trigger measurements message 722 in step 724, performs measurements. In step 758 UE 1A 124 generates a measurement report 762, and in step 760 UE 1A 124 sends the generated measurement report 762 to PMS 114. In step 764 PMS 114 receives measurement report 762, recovers the communicated information and stores the recovered information in a database.

In step 766 UE NA 126, in response to receiving trigger measurements message 728 in step 730, performs measurements. In step 768 UE NA 126 generates a measurement report 772, and in step 770 UE NA 126 sends the generated measurement report 772 to PMS 114. In step 774 PMS 114 receives measurement report 772, recovers the communicated information and stores the recovered information in a database.

In step 776 UE 1B 128, in response to receiving trigger measurements message 734 in step 736, performs measurements. In step 778 UE 1B 128 generates a measurement report 782, and in step 780 UE 1B 128 sends the generated measurement report 782 to PMS 114. In step 784 PMS 114 receives measurement report 782, recovers the communicated information and stores the recovered information in a database.

In step 786 UE NB 130, in response to receiving trigger measurements message 740 in step 742, performs measurements. In step 788 UE NB 130 generates a measurement report 792, and in step 790 UE NB 130 sends the generated measurement report 792 to PMS 114. In step 794 PMS 114 receives measurement report 792, recovers the communicated information and stores the recovered information in a database.

In step 795 UE 1C 132, in response to receiving trigger measurements message 746 in step 748, performs measurements. In step 7951 UE 1C 132 generates a measurement report 7953, and in step 7952 UE 1C 132 sends the generated measurement report 7953 to PMS 114. In step 7954 PMS 114 receives measurement report 7953, recovers the communicated information and stores the recovered information in a database.

In step 7955 UE NC 134, in response to receiving trigger measurements message 752 in step 754, performs measurements. In step 7956 UE NC 134 generates a measurement report 7958, and in step 7957 UE NC 134 sends the generated measurement report 7958 to PMS 114. In step 7959 PMS 114 receives measurement report 7958, recovers the communicated information and stores the recovered information in a database.

Steps 756, 758, 760, 764, 766, 768, 770, 774, 776, 778, 780, 784, 786, 788, 790, 794, 795, 7951, 7952, 7954, 7955, 7956. 7957, 7959) may be, and generally are repeated multiple times as the UEs move throughout the wireless coverage area during the time interval for measurement and data collection for grid generation.

Thus, in steps (764, 774, 784, 794, 7954, 7954) the PMS 114 stores signal measurement report information including information indicating base station signal strength information (RSSI values) measured by UEs, at different geographic locations. For example, a UE at a geographic location, reports, one or more sets of measurement information, each set of measurement information (RSSI, RSRQ, SINR) corresponding to a base station (e.g., the UEs current serving base station or a neighbor base station) which was detected, along with information identifying the particular base station (e.g., a PCI value) to which the measurement set corresponds, and information identifying the UE location.

In step 796 the PMS 114 determines that the data collection is complete. In step 798 PMS 114 generates notification message 800 to analytics server 110 indicating that the requested data collection has completed. In step 802, the analytics server 110 receives notification message 802, and in response, in step 804 analytics server 110 generates and sends a grid creation request or command message 806 to AI grid function 108, which receives message 806 in step 808. In step 810, in response to the received grid creation request or command message 806, the AI grid function 108 creates a grid based on data collected from UEs and stored in the PMS database. Grid creation step 810 includes steps 811, 812, 814, 816, 818 and 820. In step 811 the AI grid function 108 processes stored reported signal measurement information including signal measurements made by UEs at different locations to generate the grid information. Step 811 includes steps 812, 814, 816 and 818. In step 812 the AI grid function 108 determines one or more grid tile sizes for the tiles of a grid for which the grid information is being determined. In some embodiments, in step 812 the AI grid function 108 determines a single grid tile size. In some embodiments, in step 812 the AI grid function 108 determines multiple grid tile sizes.

In some embodiments, the reported signal measurement information includes at least one signal measurement from the geographic area to which a grid tile corresponds. For example, in some cases grid tiles are larger in size for areas for which fewer signal measurements are included in the stored measurement information and smaller for areas where a larger number of signal measurements are included per unit area in the stored measurement information.

In step 814 the AI grid function 108 determines a geographic location for each grid tile for which grid information is being generated. In step 816 the AI grid function 108 selects a base station (PCI) to be the preferred serving cell for each grid tile in the grid for which grid information is being generated. In step 818 the AI grid function 108 generates a table, e.g., including PCIs, RSRPs, RSRQs, SINRs and serving/neighbor designations, for each grid tile. In step 820 the AI grid function 108 stores the grid information in a database, e.g., a grid database accessible to the analytics server 110 and/or UEs (124, 126, 128, 130, 132, 134).

In step 821 the analytics server 110 starts a grid update timer. In various embodiments the grid update timer is used to determine when to trigger another set of measurements to be performed, collected, and evaluated to update the AI grid, in the absence of any special events, alarms, or outages, which might trigger an AI grid update. In some embodiments, the grid update timer is a countdown timer, set with an initial value representative of a predetermined time between updates, and when the grid update timer reaches 0, this triggers a grid update process to be initiated, said grid update process including generating and sending trigger measurement messages to BSs and/or UEs. In other embodiments, the grid update timer starts with a value of 0 and counts up to a predetermined update time threshold value, which when reached triggers the grid update process including generating and sending trigger measurement messages to BSs and/or UEs. In some embodiments, the time between grid updates, e.g., the predetermined update time value, is a relatively large time interval, e.g., several weeks or a month. Thus, a generated AI grid may be, and sometimes is, used for a relatively long time interval, e.g., in making handover and/or re-selection decisions, without requiring UEs to perform and report new sets of measurements; and this approach reduces overhead signaling and allows the UEs to reduce power consumption.

In step 822 BS A1 116 is operated to support a connection with UE 1A 124. In step 825 UE 1A 124 is operated to have a connection, e.g. a RRC active connection, with BS A1 116. In steps 826 and 828, BS 1A 116 and UE 1A 824 are operated, respectively, to communicate signals 830 as part of an ongoing connection. In steps 832 and 834, UE 1A 124 and analytics server 110 are operated to communicate signals 836, via BS A1 116. Communicated signals 836 includes signals conveying information which allows the analytics server 110 to monitor UE 1A's current location, changes in location, and/or direction of motion, e.g., with regard to its grid tile location. In some embodiments, communicated signals 836 includes measurement report information corresponding to UE 1A measurements of signals, which were transmitted from UE 1A's current serving base station, which is BSA 1 116. Step 832, in some embodiments, includes steps 838, 844, and 852; and step 834, in some embodiments, includes steps 842, 848 and 854. In step 837, UE 1A 124 determines the current location of UE 1A 124. In step 838 UE 1A 124 generates and sends UE 1A location information 840, e.g., a determined UE 1A position fix, GPS information, location coordinates information, and/or grid ID information, to analytics server 110, which receives and stores the UE 1A location information 840 in step 842. The UE 1A location information 840 communicates information, which when processed by analytics server 110, indicates that UE 1A 124 is currently located in the grid tile corresponding to BS A1 118 (PCI=116). In step 844 UE 1A 124 generates and sends UE 1A motion information 846, e.g., heading and/or velocity information, to analytics server 110, which receives and stores the UE 1A motion information 846 in step 848.

In step 850 UE 1A 124 moves to a location (into a grid tile) in which BS B1 (PCI=33) is the preferred serving BS. In step 851 UE 1A 124 determines the current location of UE 1A 124, which is a new location. In step 852, UE 1A 124 generates and sends information 853, e.g., information indicating a new location of UE 1A 124, which, when processed by the analytics server 110, indicates that UE 1A 124 has moved from a grid tile in which BS 1A is the preferred serving BS to a grid tile in which another BS (BS B1) is the preferred serving base station. For example, information 853 includes a UE 1A current UE 1A position fix indicating a location which is within the area of the grid tile, e.g., grid tile B16 453, corresponding to BS B1 118.

In step 854, the analytics server 110 receives and recovers the communicated information 853, e.g., information indicating a current position fix for UE 1A 124. The analytics server 110 processes the received information and determines that UE 1A is now currently located within a grid tile in which another BS (e.g., BS B1 (PCI=33), which is different than UE 1A's current serving BS (which is BS A1 (PCI=21), is the preferred serving BS. For example, analytics server 110 is aware that UE 1A is currently using BS 1A 116 as its serving BS. The analytics server 110 determines the current location of UE 1A 124 based on the position fix communicated in information 853. The analytics server 110 accesses the AI grid database, including information indicating the coverage area for each grid tile, and determines (e.g., identifies) which particular grid tile (e.g., grid tile B16 453) includes the current location (from information 853) of UE 1A 124. Then the analytics server 110 accesses the stored table in the AI grid database corresponding to the identified grid tile (e.g., grid tile B16 453) and retrieves information identifying the preferred serving base station for the identified grid tile, which is BS B1 (PCI=33).

Thus, in step 856 analytics server 110 detects movement of UE 1A 124 from a first grid tile (e.g., grid tile A13 403) in which BS A1 (PCI=21) is the preferred serving BS to a second grid tile (e.g., grid tile B16 453). In step 857 analytics server 110 determines from stored AI grid information that BS B1 (PCI=33) is the preferred serving BS for the second grid tile (e.g., grid tile B16 453).

In step 858, analytics server 110 determines to initiate a handover for UE 1A 124 from BS A1 116 to BS B1 118. In step 860 the analytics server 110 generates and sends a request or command message 862, to start handover of UE 1A 124 from BS A1 116 to BS B1 118, to BS A1 116. The request of command message 862 includes information identifying UE 1A, information identifying the source BS, which is BS A1 116, and information identifying the target BS, which is BS B1 118.

In step 864, BS A1 116 receives the request or command message 862 to start the handover of UE 1A 124 from BS A1 116 to BS B1 118. In response to received message 862, in step 866 BS A1 116 generates and sends handover request 868 to BS B1 118. In step 870 BS B1 118 receives the handover request 868, and in response, in step 872, BS B1 118 generates and sends handover request ack 874 to BS A1 116, indicating that BS B1 118 will accept the handover of UE 1A 124. In step 876, BS A1 116 receives the handover request ack 874, and in response, in step 878, BS A1 116 generates and sends handover command 880 to UE 1A 124, which receives the handover command 880 in step 884. In response to the received handover command 880, in step 884, UE 1A 124 performs operation to complete the handover and generates and sends a handover complete message 886 to BS B1 118. In step 888 BS B1 118 receives the handover complete 886. In step 890 UE 1A 124 is operate to have a connection with BS B1 118. In step 892 BS B1 118 is operated to support a connection with UE 1A 124. UE 1A 124 and BS B1 118 are operated in steps 894 and 896, respectively, to communicate signaling 898 as part of an ongoing connection.

In steps 900 and 902, UE 1A 124 and analytics server 110 are operated to communicate signals 904, via BS B1 118. Communicated signals 904 includes signals conveying information which allows the analytics server 110 to monitor UE 1A's current location, changes in location, and/or direction of motion, e.g., with regard to its grid tile location. In some embodiments, communicated signals 904 includes measurement report information corresponding to UE 1A measurements of signals, which were transmitted from UE1A's current serving base station, which is now BS B1 118.

In step 906 UE 1A 124 transitions from active mode into idle mode with BS B1 (PCI=33) being the primary serving cell. In steps 908 and 910, BS B1 118 and UE 1A 124, respectively, are operated to communicate signals 912 (signals between UE 1A 124 with its current primary serving cell, which is BS B1 (PCI=33), said signaling being during wake up intervals but without an active RRC connection. In step 914 and 916, UE 1A 124 and analytics server 110 communicate signals 918, via BS B1 118 during wake up intervals. Communicated signals 918 includes signals conveying information which allows the analytics server 110 to monitor UE 1A's current location, changes in location, and/or direction of motion, e.g., with regard to its grid tile location.

In step 919 UE 1A 124 moves to a location (into a grid tile) in which BS A1 (PCI=21) is the preferred serving BS. In step 920 UE 1A 124 determines its current location. In step 921 UE 1A 124 generates and sends user monitoring per grid signaling 922 including UE 1A location 9221 to analytics server 110 via BS B1 118 during a wake up time interval. In step 923 analytics server 110 receives signal 922 and recovers the communication UE 1A location 9221.

In step 924 analytics server 110 determines, using the received UE 1A location information 9221 and stored AI grid database information, that UE 1A 124 is now located in grid tile in which BS A1 (PCI=21) is the preferred.

In step 925 analytics server 110 generates and sends, via BS B1 118 during a wake up time interval, a request or command message 926 to trigger UE 1A 124 to perform cell re-selection and to select cell BS A1 (PCI=21) as its new primary cell. In step 927, UE 1A 124 receives the request or command message to perform reselection. In step 928, in response to received message 926, UE 1A 124 performs cell re-selection as selects cell BS A1 (PCI=21) as its new primary cell without performing measurements.

In step 929 BS A1 116 generates and sends system information 930, e.g., as part of broadcast signaling. In step 932 UE 1A 124 receives signals 930 and recovers the communicated system information. In step 934, UE 124, uses the recovered system information and operates in idle mode with BS A1 124 (PCI=21) being its primary serving cell.

In steps 936 and 938, BS A1 116 and UE 1A 124, respectively, are operated to communicate signals 940 (signals between UE 1A 124 with its current primary serving cell, which is now BS A1 (PCI=21), said signaling being during wake up intervals but without an active RRC connection.

In step 942 and 944, UE 1A 124 and analytics server 110 communicate signals 946, via BS A1 116 during wake up intervals. Communicated signals 946 includes signals conveying information which allows the analytics server 110 to monitor UE 1A's current location, changes in location, and/or direction of motion, e.g., with regard to its grid tile location.

In step 948 EMS 112 detects an event or receives a report of an event, e.g., a notification that the system is being updated to include one or more new base stations, a notification that a base station is to go offline for maintenance, a notification of a change in base station transmit power levels, etc. In some embodiments, the detected event is a detection that the grid update timer (e.g., started in step 821) has reached its limit, e.g. a grid update countdown timer has reached 0, or a grid update timer, which counts up, has reached its predetermined threshold, to trigger an AI grid update process.

In step 950 EMS 112 receives an alarm, e.g., indicating a hardware fault in the system, indicating a failed communications link, indicating an attack, e.g., a denial of service (DOS) attack, or indicating another problem in the system.

In step 952 the EMS detects an outage or receives a report of an outage, e.g., an indication that a particular base station is experiencing an outage or information indicating a particular portion of the network is experiencing an outage.

In step 954, in response to any of steps 948, 950 of 952 being performed, EMS 112 generates and sends a trigger notification message 956 of an event, alarm, or outage to the analytics server. In step 958 the analytics server 110 receives trigger notification message 956 and recovers the communicated information, e.g. indicating the type of issue or problem and/or information indicating the wireless coverage area being affected. In step 960, the analytics server generates and sends a trigger notification message 962 of an event, alarm, or outage to the AI grid function 108. In some embodiments, message 962 is a forwarded copy of message 956. In other embodiments, message 962 is a processed copy of message 956 based on additional stored performance information, e.g., reported KPIs, available to the analytics server. In step 964 AI grid function 108 receives trigger notification message 962 and recovers the communicated information. In step 966, in response to received message 962, AI grid function 108 generates and sends a request or command message 968 to EMS 112. Request or command message 968 requests or commands the EMS 112 to modify configuration management (CM) parameters (e.g., exemplary CM parameters include: measurement status, report_interval, report_amount, max_report_cells) to trigger event specific measurements. In step 970 EMS 112 receives the request or command message 968 and performs the CM parameter modification to trigger event specific measurements, e.g., sending control messages to the core network, base stations, and/or UEs.

In step 972 analytics server 110 generates and sends trigger measurements message 974 to BS A1 116, which is received by BS A1 116 in step 976. In step 978 analytics server 110 generates and sends trigger measurements message 980 to BS B1 118, which is received by BS B1 118 in step 982. In step 984 analytics server 110 generates and sends trigger measurements message 986 to BS C1 120, which is received by BS C1 120 in step 988.

In step 990 BS A1 116, in response to receiving message 974 in step 976, generates and transmits trigger measurements message 992 to UE 1A 124, which is received by UE 1A 124 in step 9944. In step 996 BS A1 116, in response to receiving message 974 in step 976, generates and transmits trigger measurements message 998 to UE NA 126, which is received by UE NA 126 in step 1000.

In step 1002 BS B1 118, in response to receiving message 980 in step 982, generates and transmits trigger measurements message 1004 to UE 1B 128, which is received by UE 1B 128 in step 1006. In step 1008 BS B1 118, in response to receiving message 980 in step 982, generates and transmits trigger measurements message 1010 to UE NB 130, which is received by UE NB 130 in step 1012.

In step 1014 BS C1 120, in response to receiving message 986 in step 988, generates and transmits trigger measurements message 1016 to UE 1C 132, which is received by UE 1C 132 in step 1018. In step 1020 BS C1 120, in response to receiving message 986 in step 988, generates and transmits trigger measurements message 1024 to UE NC 134, which is received by UE NC 140 in step 1026.

In step 1028 UE 1A 124, in response to receiving trigger measurements message 992 in step 994, performs measurements. In step 1030 UE 1A 124 generates a measurement report 1034, and in step 1032 UE 1A 124 sends the generated measurement report 1034 to PMS 114. In step 1036 PMS 114 receives measurement report 1034, recovers the communicated information and stores the recovered information in a database.

In step 1038 UE NA 126, in response to receiving trigger measurements message 998 in step 1000, performs measurements. In step 1040 UE NA 126 generates a measurement report 1044, and in step 1042 UE NA 126 sends the generated measurement report 1044 to PMS 114. In step 1046 PMS 114 receives measurement report 1044, recovers the communicated information and stores the recovered information in a database.

In step 1048 UE 1B 128, in response to receiving trigger measurements message 1004 in step 1006, performs measurements. In step 1050 UE 1B 128 generates a measurement report 1054, and in step 1056 UE 1B 128 sends the generated measurement report 1052 to PMS 114. In step 1056 PMS 114 receives measurement report 1054, recovers the communicated information and stores the recovered information in a database.

In step 1058 UE NB 130, in response to receiving trigger measurements message 1012 in step 1012, performs measurements. In step 1060 UE NB 130 generates a measurement report 1064, and in step 1062 UE NB 130 sends the generated measurement report 1064 to PMS 114. In step 1066 PMS 114 receives measurement report 1064, recovers the communicated information and stores the recovered information in a database.

In step 1067 UE 1C 132, in response to receiving trigger measurements message 746 in step 748, performs measurements. In step 1068 UE 1C 132 generates a measurement report 1070, and in step 1069 UE 1C 132 sends the generated measurement report 1070 to PMS 114. In step 1071 PMS 114 receives measurement report 1071, recovers the communicated information and stores the recovered information in a database.

In step 1072 UE NC 134, in response to receiving trigger measurements message 1024 in step 1026, performs measurements. In step 1073 UE NC 134 generates a measurement report 1075, and in step 1074 UE NC 134 sends the generated measurement report 1075 to PMS 114. In step 1076 PMS 114 receives measurement report 1075, recovers the communicated information and stores the recovered information in a database.

Steps 1028, 1030, 1032, 1036, 1038, 1040, 1042, 1046, 1048, 1050, 1052, 1056, 1058, 1060, 1062, 1066, 1067, 1068, 1069, 1071, 1072, 1073, 1074, 1076) may be, and generally are repeated multiple times as the UEs move throughout the wireless coverage area during the time interval for measurement and data collection for grid update generation.

Thus, in steps (1036, 1046, 1056, 1058, 1066, 1071, 1076) the PMS 114 stores signal measurement report information including information indicating base station signal strength information (RSSI values) measured by UEs, at different geographic locations. For example, a UE at a geographic location, reports, one or more sets of measurement information, each set of measurement information (RSSI, RSRQ, SINR) corresponding to a base station (e.g., the UEs current serving base station or a neighbor base station) which was detected, along with information identifying the particular base station (e.g., a PCI value) to which the measurement set corresponds, and information identifying the UE location.

In step 1077 the PMS 114 determines that the data collection is complete. In step 1078 PMS 114 generates and sends notification message 1079 to analytics server 110 indicating that the requested data collection has completed. In step 1080, the analytics server 110 receives notification message 1079, and in response, in step 1081 analytics server 110 generates and sends a grid update request or command message 1082 to AI grid function 108, which receives message 1082 in step 1083. In step 1084, in response to the received grid update request or command message 1082, the AI grid function 108 updates the previously created grid based on data collected from UEs and stored in the PMS database. Grid update step 1084 includes one or more or all of: steps 10841, 1085, 1086, 1087, 1088 and 1089. In some embodiments, during some iterations of step 1084, a first portion of a previously created grid is updated, with a second portion of the previously created grid remaining unchanged.

In step 10841 the AI grid function 108 processes stored reported signal measurement information including signal measurements made by UEs at different locations to generate updated grid information. Step 10841 includes steps 1085, 1086, 1087 and 1088. In step 1085 the AI grid function 108 determines one or more grid tile sizes. In step 1086 the AI grid function 108 determines a geographic location for each grid tile. In step 1087 the AI grid function 108 selects a base station (PCI) to be the preferred serving cell for each grid tile. In step 1088 the AI grid function 108 generates a table, e.g., including PCIs, RSRPs, RSRQs, SINRs and serving/neighbor designations, for each grid tile. In step 1089 the AI grid function 108 stores the grid information in a database, e.g., a grid database accessible to the analytics server 110 and/or UEs (e.g., UE 1A 124, UE NA 126, UE 1B 128, UE NB 130, UE 1C 132, UE NC 134).

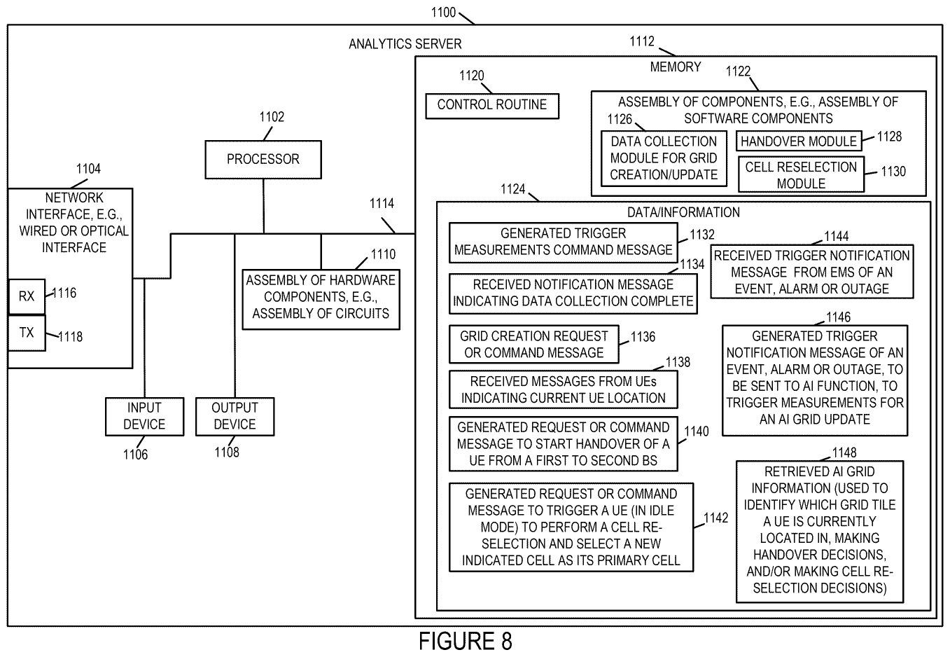

FIG. 8 is a drawing of an exemplary analytics server 1100 in accordance with an exemplary embodiment. Analytics server 1100 is, e.g., analytics server 110 of system 100 of FIG. 1 or FIG. 2, and/or analytics server 110 of signaling diagram 700 of FIG. 7 and/or an analytics server implementing steps of a method, e.g., the method of flowchart 300 of FIG. 3. Exemplary analytics server 1100 includes a processor 1102, e.g., a CPU, a network interface 1104, an input device 1106, e.g., a keyboard, an output device 1108, e.g., a display, an assembly of hardware components 1110, e.g., an assembly of circuits, and memory 1112 coupled together via a bus 1114 over which the various elements may interchange data and information.

Network interface 1104, e.g., a wired or optical interface, includes a receiver 1116 and a transmitter 1118. Network interface 1104 couples the analytics server 1100 to network nodes and/or the Internet.

Memory 1112 includes a control routine 1120, an assembly of components 1122, and data/information 1124. Control routine 1120 includes instructions, which when executed by processor 1102 control the analytics server 1100 to perform basic device operational functions such as, e.g., controlling the network interface 1104, controlling input device 1106, controlling output device 1108, accessing memory 1112, storing in memory 1112, etc. Assembly of components 1122, e.g., an assembly of software components, includes instructions, which when executed by processor 1102 control the analytics server 1100 to implement steps of a method, e.g., steps of the method of flowchart 300 of FIG. 3, and/or steps of the signaling diagram 700 of FIG. 7.

Assembly of components 1122 includes a data collection module for grid creation/grid updates, a handover module 1128 for determining, when to initiate a handover, identifying the target base station, and initiating handover based on UE location information and stored AI grid information, and a cell re-selection module 1130 for determining, when to initiate cell-reselection for a UE in idle mode, identifying a new primary cell for the UE, and initiating a cell re-selection, based on UE location information and stored AI grid information. Data/information 1124 includes a generated trigger measurements command message 1132, a received notification message 1134 indicating data collection is complete, a generated grid creation request of command message 1136 to be sent to an AI grid function, received messages 1138 from UEs indicating current UE location, UE heading direction and/UE velocity information, a generated request or command message 1140 to start handover of a UE from a first BS to a second BS, a generated request or command message 1142 to trigger a UE, in idle mode, to perform cell re-selection and to select a new indicated cell as its primary cell, a received trigger notification message 1144 from an EMS providing notification of an event, alarm, or outage, a generated trigger notification message 1146 of an event, alarm, or outage, to be sent to an AI grid function to trigger measurements for an AI grid update, and retrieved AI grid information, e.g., from an AI grid database, to be used to: identify which grid tile a UE is currently located in, make handover decisions, and/o make cell re-selection decisions.

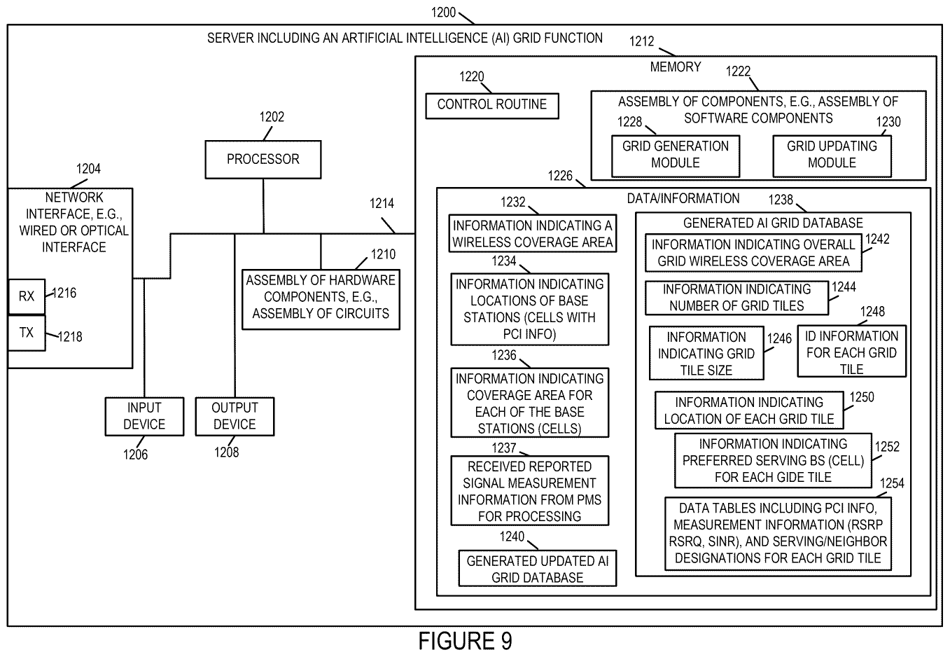

FIG. 9 is a drawing of an exemplary artificial intelligence (AI) grid function 1200 in accordance with an exemplary embodiment. AI grid function 1200 is, e.g., AI grid function 108 of system 100 of FIG. 1 or FIG. 2, and/or AI grid function 108 of signaling diagram 700 of FIG. 7 and/or an AI grid function 108 implementing steps of a method, e.g., the method of flowchart 300 of FIG. 3. Exemplary AI grid function 1200 includes a processor 1202, e.g., a CPU, a network interface 1204, an input device 1206, e.g., a keyboard, an output device 1208, e.g., a display, an assembly of hardware components 1210, e.g., an assembly of circuits, and memory 1212 coupled together via a bus 1214 over which the various elements may interchange data and information.

Network interface 1204, e.g., a wired or optical interface, includes a receiver 1216 and a transmitter 1218. Network interface 1204 couples the AI grid function 1200 to network nodes and/or the Internet.

Memory 1212 includes a control routine 1220, an assembly of components 1222, and data/information 1224. Control routine 1220 includes instructions, which when executed by processor 1202 control the AI grid function 1200 to perform basic device operational functions such as, e.g., controlling the network interface 1204, controlling input device 1206, controlling output device 1208, accessing memory 1212, storing in memory 1212, etc. Assembly of components 1222, e.g., an assembly of software components, includes instructions, which when executed by processor 1202 control the AI grid function 1200 to implement steps of a method, e.g., steps of the method of flowchart 300 of FIG. 3, and/or steps of the signaling diagram 700 of FIG. 7. Assembly of components 1222 includes a grid creation module 1228 and a grid updating module 1230. Data/information 1226 includes information 1232 indicating a wireless coverage area, information 1234 indicating locations of base stations (cells with PCI values), information 1236 indicating a coverage area for each of the base stations (cells), received reported signal measurement information from PMS for processing 1237, e.g., information accessed from PMS database 1434, a generated AI grid database 1238, and a generated updated AI grid database 1240. The generated AI grid database 1238 includes information indicating the overall grid wireless coverage area 1242, information indicating the number of grid tiles 1244, information indicating grid tile size 1246, ID information for each grid tile 1248, information indicating the location of each grid tile 1250, information indicating a preferred serving base station (cell) for each grid tile 1252 and data tables including PCI information, measurement information, e.g. RSRP, PRSQ, and SINR, and serving/neighbor designations, for each PCI value in PCI information, for each grid tile 1254.

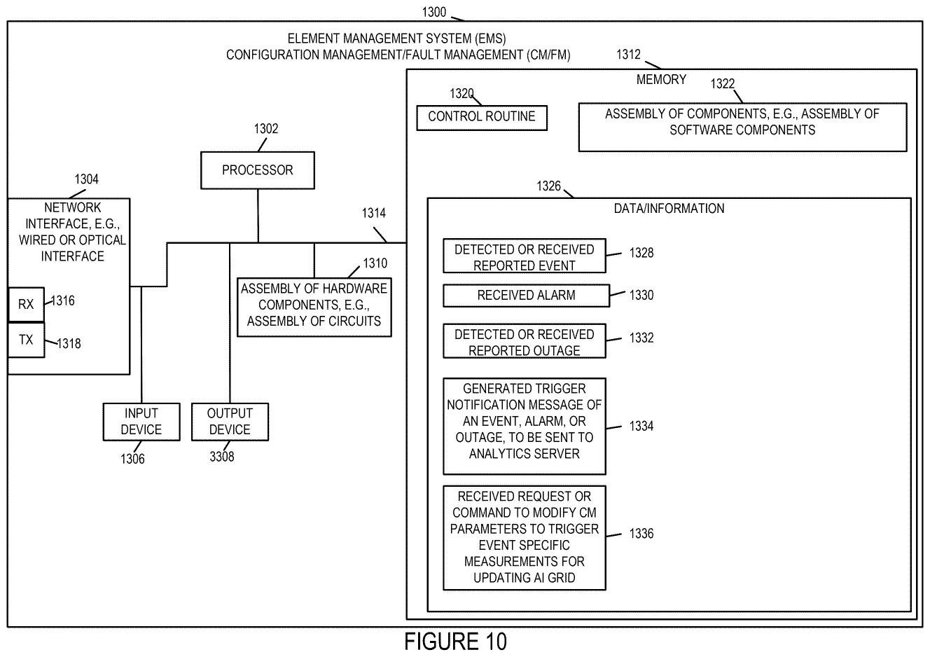

FIG. 10 is a drawing of an exemplary element management system (EMS) 1300 including configuration management (CM) and fault management (FM) in accordance with an exemplary embodiment. EMS 1300 is, e.g., EMS 112 of system 100 of FIG. 1 or FIG. 2, and/or EMS 112 of signaling diagram 700 of FIG. 7 and/or an EMS implementing steps of a method, e.g., the method of flowchart 300 of FIG. 3. Exemplary EMS 1300 includes a processor 1302, e.g., a CPU, a network interface 1304, an input device 1306, e.g., a keyboard, an output device 1308, e.g., a display, an assembly of hardware components 1310, e.g., an assembly of circuits, and memory 1312 coupled together via a bus 1314 over which the various elements may interchange data and information.

Network interface 1304, e.g., a wired or optical interface, includes a receiver 1316 and a transmitter 1318. Network interface 1304 couples the EMS 1300 to network nodes and/or the Internet.

Memory 1312 includes a control routine 1320, an assembly of components 1322, and data/information 1324. Control routine 1320 includes instructions, which when executed by processor 1302 control the EMS 1300 to perform basic device operational functions such as, e.g., controlling the network interface 1304, controlling input device 1306, controlling output device 1308, accessing memory 1312, storing in memory 1312, etc. Assembly of components 1322, e.g., an assembly of software components, includes instructions, which when executed by processor 1302 control the EMS 1300 to implement steps of a method, e.g., steps of the method of flowchart 300 of FIG. 3, and/or steps of the signaling diagram 700 of FIG. 7.

Data/information 1326 includes information indicating a detected of received reported event 132, a received alarm 1330, information indicating a detected or received reported outage 1332, a generated trigger notification message 1334, of an event, alarm or outage, to be sent to an analytics server, and a received request or command message 1336, requesting CM of an EMS to modify CM parameters, e.g., to trigger event specific measurements, for updating an AI grid.

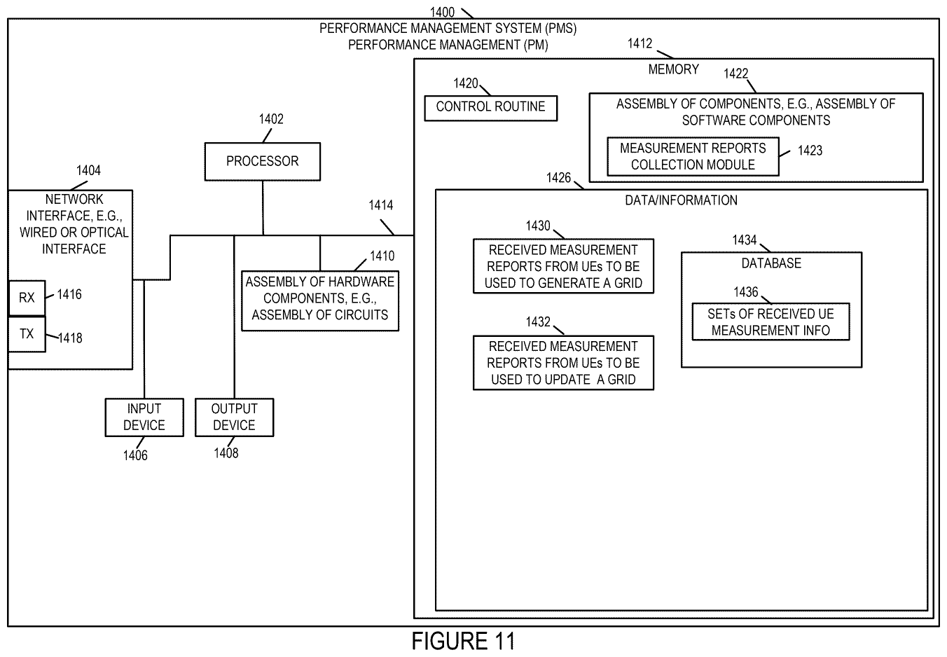

FIG. 11 is a drawing of an exemplary performance management system (PMS) 1400 including performance management (PM) in accordance with an exemplary embodiment. PMS 1400 is, e.g., PMS 114 of system 100 of FIG. 1 or FIG. 2, and/or PMS 114 of signaling diagram 700 of FIG. 7 and/or a PMS implementing steps of a method, e.g., the method of flowchart 300 of FIG. 3. Exemplary PMS 1400 includes a processor 1402, e.g., a CPU, a network interface 1404, an input device 1406, e.g., a keyboard, an output device 1408, e.g., a display, an assembly of hardware components 1410, e.g., an assembly of circuits, and memory 1412 coupled together via a bus 1414 over which the various elements may interchange data and information.

Network interface 1404, e.g., a wired or optical interface, includes a receiver 1416 and a transmitter 1418. Network interface 1404 couples the PMS 1400 to network nodes and/or the Internet.

Memory 1412 includes a control routine 1420, an assembly of components 1422, and data/information 1424. Control routine 1420 includes instructions, which when executed by processor 1402 control the PMS 1400 to perform basic device operational functions such as, e.g., controlling the network interface 1404, controlling input device 1406, controlling output device 1408, accessing memory 1412, storing in memory 1412, etc. Assembly of components 1422, e.g., an assembly of software components, includes instructions, which when executed by processor 1402 control the PMS 1400 to implement steps of a method, e.g., steps of the method of flowchart 300 of FIG. 3, and/or steps of the signaling diagram 700 of FIG. 7. Assembly of components 1422 includes a measurement reports collection module 1423 for collecting UE measurements reports, e.g., from a plurality of UEs, during a measurement time interval, which can be used, e.g., by an AI grid function, to create and/or update, an AI grid including grid tiles, for a wireless network coverage area. Data/information 1426 includes received measurements reports 1430 from UEs, corresponding to a first data collection time period, to be used to generate an AI grid, and received measurements reports 1432 from UEs, corresponding to a second data collection time period, to be used to update an existing AI grid. Database 1434 includes stored sets 1436 of received UE measurement information. Database 1434 may be, and sometimes is, accessed by an AI grid function.

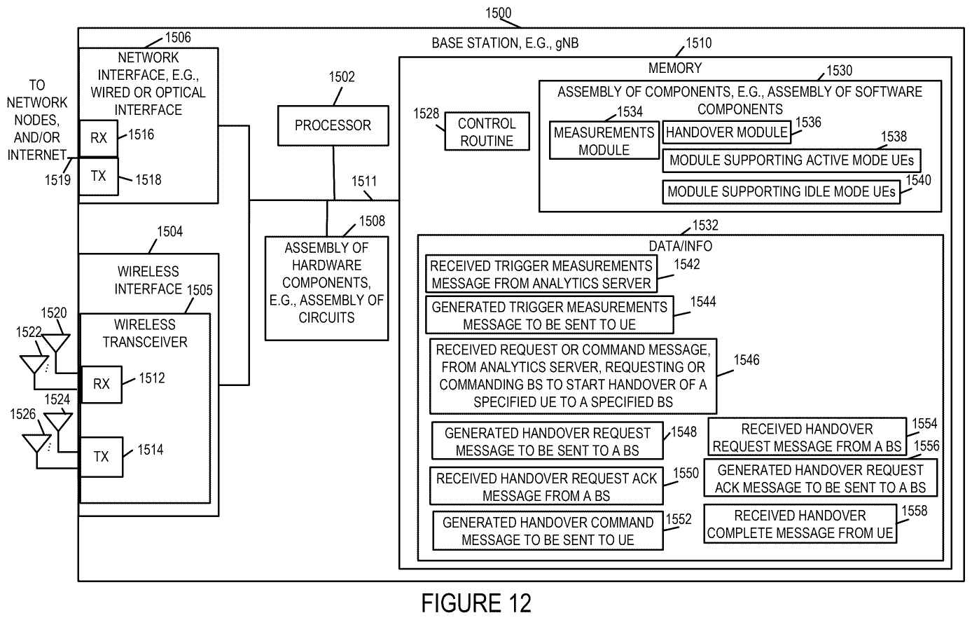

FIG. 12 is a drawing of an exemplary base station 1500, e.g., a gNB, in accordance with an exemplary embodiment. Base station 1500 is, e.g., any of the base stations (base station A1 (BS A1) 116, base station B1 (BS B1) 118, base station C1 (BS C1) 120, . . . , base station N1 (BS N1) 122 of system 100 of FIG. 8 or FIG. 2, and/or a base station, e.g., a gNB, implementing steps of a method, e.g., the method of flowchart 300 of FIG. 3 and/or the method of signaling diagram 700 of FIG. 7. Exemplary base station 1500 includes a processor 1502, e.g., a CPU, a wireless interface 1504, a network interface 1506, an assembly of hardware components 1508, e.g., an assembly of components, and a memory 1510 coupled together via a bus 1511 over which the various elements may interchange data and information. Wireless interface 1504 includes a wireless receiver 1512 coupled to one or more receive antennas (1520, . . . 1522) and a wireless transmitter 21514 coupled to one or more transmit antennas (1524, . . . , 1526). In some embodiments the wireless receiver 1512 and wireless transmitter 1514 are included as part of a transceiver 1505, e.g., a transceiver chip.

Network interface 1506, e.g., a wired or optical interface, includes a receiver 1516 and a transmitter 1518 coupled to an interface connector 1519, which couples the base station 1500 to network nodes including, and/or the Internet. Memory 1510 includes a control routine 1528, an assembly of components 1530, e.g., an assembly of software components, and data/information 1532.

Assembly of components 1530 includes a measurements module 1534, a handover module 1536, a module 1538 supporting active mode UEs, e.g., UEs having an RRC connection with BS 1500, and module 1540 supporting idle mode UEs, e.g., UEs in idle mode which are using BS 1500 as their primary cell. Data/information 1532 includes a received trigger measurements message 1542 from an analytics server, a generated trigger measurements message 1544 to be sent to a UE, said message instructing the UE to perform measurements of base stations (cells) which can be detected by the UE and send measurement reports, e.g., to a performance management system. Data/information 1532 further includes a received request or command message 1546, e.g., from an analytics server, requesting or commanding BS 1500 to start a handover to a specified UE to a specified BS, a generated handover request message 1548 to be sent to the specified BS indicated by message 1546, a received handover request acknowledgment (ack) message 1550 from the BS to which message 1548 was sent, and a generated handover command message 1552 to be sent to the UE being handed over.

Data/information 1532 further includes a received handover request message 1554 from a BS, which is the current serving BS for a UE, a generated handover request ack message 1556 to be sent to the BS, which send message 1554, and a received handover complete message from a UE, which has been successfully handed over to BS 1500.

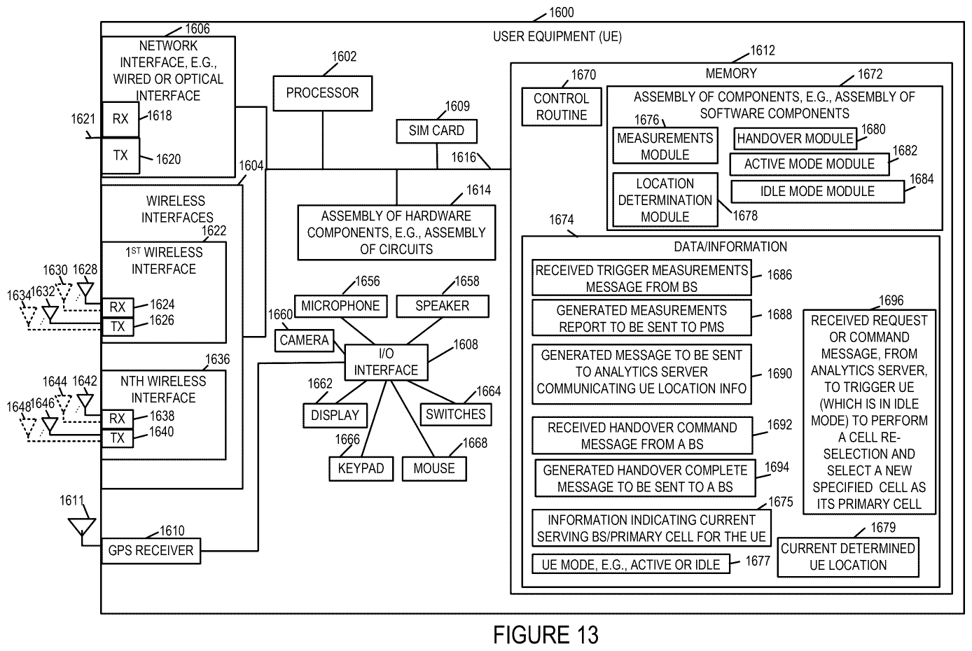

FIG. 13 is a drawing of an exemplary user equipment (UE) 1600 in accordance with an exemplary embodiment. Exemplary UE 1600 is, e.g., any of the UEs (124, 126, 128, 130, 132, 134, 136, 138) of system 100 of FIG. 1 or FIG. 2 or of signaling diagram 700 of FIG. 7, and/or a UE, implementing steps of a method, e.g., the method of flowchart 300 of FIG. 3. UE 2600 includes processor 1602, e.g., a CPU, a wireless interface 1604, network interface 1606, I/O interface 1608, Subscriber Identity module (SIM) card 1609, GPS receiver 1610, memory 1612 and assembly of hardware components 1614, e.g., an assembly of circuits, coupled together via bus 1616 over which the various elements may exchange data and information.

Wireless interfaces 1604 includes a plurality of wireless interfaces (1st wireless interface 1622, . . . ., Nth wireless interface 1636). 1st wireless interface 1622 includes wireless receiver (RX) 1624 and wireless transmitter (TX) 1626. Wireless receiver 1624 is coupled to one or more receive antennas or antenna elements (1628, . . . , 1630) via which the UE 1600 receives wireless signals from a radio access network node, e.g., a base station, e.g., a gNB. Wireless transmitter 1626 is coupled to one or more transmit antennas or antenna elements (1632, . . . , 1634) via which the UE 1600 transmits wireless signals to radio access network node, a base station, e.g., a gNB. In some embodiments, the same antennas are used for transmit and receive with regard to the 1st wireless interface 1622. Nth wireless interface 1636 includes wireless receiver (RX) 1638 and wireless transmitter (TX) 1640. Wireless receiver 1638 is coupled to one or more receive antennas or antenna elements (1642, . . . , 1644) via which the UE 1600 receives wireless signals, e.g., from a radio access network node, e.g., a base station, e.g., gNB. Wireless transmitter 1640 is coupled to one or more transmit antennas or antenna elements (1646, . . . , 1648) via which the UE 1600 transmits wireless signals, e.g., to a radio access network node, e.g., base station, e.g., a gNB. In some embodiments, the same antennas are used for transmit and receive with regard to the 2nd wireless interface 1636. In some embodiments the 1st wireless interface 1622 and the nth wireless interface 1636 are used for different communications bands and/or correspond to different technologies.

Network interface 1606, e.g., a wired or optical interface, includes receiver 1618, transmitter 1620 and connector 1621. Network interface 1606 allows the UE 1600 to connect to a wired or optical interface when the UE 1600 is stationary and the wired or optical interface is available.

GPS receiver 1610 is coupled to GPS antenna 1611 via which the UE 1600 receives GPS signals used to determine UE position and velocity. UE 1600 further includes a plurality of I/O devices (microphone 1656, speaker 1658, camera 1660, display 1662, e.g., a touch screen display, switches 1664, keypad 1666, and mouse 1668) coupled to I/O interface 1608 via which the various I/O devices may interact with other elements within UE 1600.

Memory 1612 includes a control routine 1670, an assembly of components 1672, e.g., an assembly of software components, and data/information 1674. Assembly of components 1672 includes measurements module 1686, location determination module 1678, handover module 1680, active mode module 1682 and idle mode module 1684. Data/information 1674 includes information 1675 indicating the current serving BS/primary cell for UE 1600, information 1677 identifying the current UE mode of operation, e.g., active mode or idle mode, and a current determined UE 1600 location 1679. Data/information 1674 further includes received trigger measurements message 1686 from a BS, a generated measurements report 1688 to be sent to a PMS, a generated message 1690 to be sent to an analytics server communicating UE location information, a received handover command message 1692 from a BS, a generated handover complete message 1694 to be sent to a BS, and a received request or command message 1696, e.g., from an analytics server, to trigger the UE 1600, which is in idle mode, to perform a cell re-selection operation and select a new specified cell as its primary cell.

Various aspects and/or features of some embodiments of the present invention are described below. Advantages of the proposed solution, in accordance with the present invention, include: i) an uplink (UL) overhead improvement over the existing approach by skipping measurements; ii) UE device battery life improvement and time between battery re-charge improvement due to the elimination or reduction of measurements being performed periodically to detect available cells; and iii) handover time/latency enhancements by skipping measurement step in the decision process.

### NUMBERED LIST OF EXEMPLARY METHOD EMBODIMENTS

Method Embodiment 1. A method of supporting communication using base stations, the method comprising: storing (820) grid information (e.g., in a storage device in or accessible to an analytics server 110) corresponding to a geographic area, said grid information (404, 454) including for each of a plurality of tiles (A13 403, B16 453, etc.) of a grid (e.g., grid 402) corresponding to the geographic area (e.g., the physical geographic area to which grid 402 corresponds): i) tile size information, ii) tile location information and iii) preferred serving cell information (e.g., information indicating a preferred base station (e.g., represented by a corresponding PCI) for the grid tile to which the information corresponds); detecting (856) (e.g., at analytics server 110) movement of a first UE (e.g., UE 1A 124) from a first grid tile area in which a first base station (BS A1 116 with PCI=21) is a preferred base station to a second grid tile area; determining (857) from the stored grid information (404, 454) that a second base station (e.g., BS B1 with PCI=33), different from the first base station, is the preferred base station for the second grid tile; and initiating (859) a handover from the first base station (BS A1 116) to the second base station (e.g., BS B1 118) in response to determining that the second base station (BS B1 118) is the preferred base station for the grid tile area into which the first UE (e.g., UE 1A 124) has moved.

Method Embodiment 1A. The method of Method Embodiment 1, wherein said initiating (859) a handover of the first UE (UE 1A 124) is made based on UE position information and stored grid information, said stored grid information having been stored prior to the first UE moving into the second grid tile area.

Method Embodiment 1B. The method of Method Embodiment 1A, where said initiating a handover was triggered based on the location of the first UE without considering (recently performed) signal strength measurement information from the first UE (UE 1A 124) or first base station (BS A1 116) providing service to the first UE prior to movement of the first UE into the second grid tile. (In some cases the grid may have been generated based on signal measurements by the first UE and/or other UEs but the handoff decision is based on location and the stored grid information and not signal strength measurements provided at or shortly before the handoff decision and in some cases the grid information may have been generated without any power measurement corresponding to the second tile area from the first UE with the signal power measurement corresponding to the second grid tile used in determining the grid having been provided by one or more other UEs, e.g. a second UE in some embodiments.)

Method Embodiment 2. The method of Method Embodiment 1, wherein initiating (859) a handover from the first base station (BS A1 116) to the second base station (BS B1 118) includes sending (860) a handover signal (e.g., a request or command (862) to start a handover of UE 1A from BS A1 116 to BS B1 118) to the first base station requesting or commanding the first base station to start a handover of the first UE to the second base station (BS B1 118).

Method Embodiment 3. The method of Method Embodiment 1, further comprising: determining (924) (e.g., at analytics server 110 from location information and/or status information corresponding to the first UE 1A 124) that the first UE (124), while operating in an idle mode of operation, has moved into a grid tile area with a different preferred serving base station (e.g., BS A1 with PCT=21) than a serving base station (e.g., BS B1 with PCI=33) being used by the first UE; and sending (925), in response to determining that the first UE (124) has moved into a grid tile area with a different preferred serving base station, a signal to the first UE (124) (e.g., request or command) triggering the first UE to perform cell reselection.

Method Embodiment 4. The method of Method Embodiment 3, further comprising: sending (925), in response to determining that the first UE (124) has moved into a grid tile area with a different preferred serving base station, a signal to the first UE (124) (e.g., request or command) triggering the first UE to perform cell reselection includes sending preferred base station information indicating the preferred serving base station for the grid tile area into which the first UE moved (e.g., indicate in signal to first UE that the first UE is to select BS A1 with PCI=21 as the new serving BS as part of the cell reselection process).

Method Embodiment 4A. The method of Method Embodiment 4, further comprising: operating the first UE (124) to perform (928) cell reselection while operating in idle mode with the indicated preferred serving base station (BS A1 with PCI=21) being selected as the new primary cell (e.g., without the UE performing signal measurements as part of the cell reselection operation).

Method Embodiment 5. The method of Method Embodiment 4, further comprising: receiving (944), (e.g., at analytics server 110) from the first UE (124) location information via the indicated preferred base station (e.g., BS A1), said user device location information being communicated via the first base station while the first UE is in idle mode (e.g., without the first UE establishing an active RRC connection without the first base station (BS A1 116).

Method Embodiment 6. The method of Method Embodiment 1, further comprising: sending (702, 704, 714) signals (e.g., from analytics server (110) to base stations (116, 118, 120)) to trigger UE signal measurements; and storing (764, 774, 784, 794, 7954, 7959) (e.g., at PMS 114) signal measurement report information indicating base station signal strength information measured by UEs at different geographic locations (e.g., reported received signal strength measurements and corresponding identifier of the base station to which an individual measurement corresponds is stored (e.g., UE reported signal measurement (received signal strength) and corresponding PCI is stored with different UEs reporting signal measurements made at different locations).

Method Embodiment 7. The method of Method Embodiment 6, further comprising: processing (811) stored reported signal measurement information including signal measurements made by UEs at different locations to generate said grid information.

Method Embodiment 8. The method of Method Embodiment 7, wherein said processing (811) to generate said grid information includes: determining (812) one or more grid tile sizes for tiles of a grid for which said grid information is being determined; and determining (814) a geographic location for each tile of the grid for which grid information is being generated.

Method Embodiment 8A. The method of Method Embodiment 8, wherein determining one or more grid tile sizes includes determining a single grid tile size or determining multiple different grid tile sizes.

Method Embodiment 8B. The method of Method Embodiment 8A, wherein the reported signal measurement information includes at least one signal measurement from the geographic area to which a grid tile corresponds e.g., in some cases grid tiles are larger in size for areas for which fewer signal measurements are included in the stored measurement information and smaller for areas where larger number of signal measurements are included per unit area in the stored signal measurement information).

Method Embodiment 9. The method of Method Embodiment 8, wherein processing (811) stored reported signal measurement information including signal measurements made by UEs at different locations to generate said grid information further includes: selecting (816) a base station to be a preferred serving cell for each grid tile in the grid for which grid information is being generated.

Method Embodiment 10. The method of Method Embodiment 9, wherein the stored generated grid information is stored (in step 820) in a database for use in making base station handoff or cell re-selection decisions (e.g., in a database accessible to an analytics server (110) or UEs 124, 126, etc.)).

Method Embodiment 11. The method of Method Embodiment 1, further comprising: receiving (958) a notification (e.g. at the analytics server 110) relating to a network event, alarm or outage; and triggering (972, 978, 984) measurements (e.g., send measurement messages 974, 980, 986 to base stations which in turn send measurement request messages 992, 998, 1004, 1010, 1016, 1024 to UEs) to collect information used to generate updated grid information.

Method Embodiment 11A. The method of Method Embodiment 11 wherein the received notification indicates a detected event, a received alarm or a detected outage of a network element (e.g. base station).

Method Embodiment 11B. The method of Method Embodiment 11A, wherein the detected event is expiration of a timer used to trigger a periodic grid update.

Method Embodiment 12. The method of Method Embodiment 11, further comprising: receiving (1080) notification that measurement information has been collected for updating grid information; and initiating (1081) a grid update (e.g., by sending a grid update request or command 1082 to an AI grid update function (108) following notification.

Method Embodiment 13. The method of Method Embodiment 12, further comprising: operating a grid function (108) to update (1084) grid information based on measurement information collected from multiple UEs (124, 126, 128, 130, 132, 134).

### NUMBERED LIST OF EXEMPLARY SYSTEM EMBODIMENTS

System Embodiment 1. A communications system (100) comprising: a storage device (e.g., memory 1112 in analytics server (110) or memory 1212 in a server including AI grid function 108, which is accessible to analytics server (110)) for storing (820) grid information corresponding to a geographic area, said grid information (404, 454) including for each of a plurality of tiles (A13 403, B16 453, etc.) of a grid (e.g., grid 402) corresponding to the geographic area (e.g., the physical geographic area to which grid 402 corresponds): i) tile size information, ii) tile location information and iii) preferred serving cell information (e.g., information indicating a preferred base station (e.g., represented by a corresponding PCI) for the grid tile to which the information corresponds); an analytics server (110 or 1100) including a first processor (1102) configured to operate the analytics server to: detect (856) (e.g., at the analytics server 110) movement of a first UE (e.g., UE 1A 124) from a first grid tile area in which a first base station (BS A1 116 with PCI=21) is a preferred base station to a second grid tile area; determine (857) from the stored grid information (404, 454) that a second base station (e.g., BS B1 with PCI=33), different from the first base station, is the preferred base station for the second grid tile; and initiate (859) a handover from the first base station (BS A1 116) to the second base station (e.g., BS B1 118) in response to determining that the second base station (BS B1 118) is the preferred base station for the grid tile area into which the first UE (e.g., UE 1A 124) has moved.

System Embodiment 1A. The communications system of System Embodiment 1, wherein said first processor (1102) is configured to operate the analytics server (110) to: initiate (859) the handover of the first UE (UE 1A 124) based on UE position information and stored grid information, said stored grid information having been stored prior to the first UE moving into the second grid tile area.

System Embodiment 1B. The communications system of System Embodiment 1A, wherein said first processor (1102) is configured to operate the analytics server (110) to initiate the handover based on the location of the first UE without considering (recently performed) signal strength measurement information from the first UE (UE 1A 124) or first base station (BS A1 116) providing service to the first UE prior to movement of the first UE into the second grid tile. (In some cases the grid may have been generated based on signal measurements by the first UE and/or other UEs but the handoff decision is based on location and the stored grid information and not signal strength measurements provided at or shortly before the handoff decision and in some cases the grid information may have been generated without any power measurement corresponding to the second tile area from the first UE with the signal power measurement corresponding to the second grid tile used in determining the grid having been provided by one or more other UEs, e.g. a second UE in some embodiments.)

System Embodiment 2. The communications system of System Embodiment 1, wherein said first processor (1102) is configured to operate the analytics server (110) to: send (860) a handover signal (e.g., a request or command (862) to start a handover of UE 1A from BS A1 116 to BS B1 118) to the first base station requesting or commanding the first base station to start a handover of the first UE to the second base station (BS B1 118), as part of being configured to initiate (859) a handover from the first base station (BS A1 116) to the second base station (BS B1 118).

System Embodiment 3. The communications system of System Embodiment 1, wherein said first processor (1102) is further configured to operate the analytics server (110) to: determine (924) (e.g., at analytics server 110 from location information and/or status information corresponding to the first UE 1A 124) that the first UE (124), while operating in an idle mode of operation, has moved into a grid tile area with a different preferred serving base station (e.g., BS A1 with PCT=21) than a serving base station (e.g., BS B1 with PCI=33) being used by the first UE; and send (925), in response to determining that the first UE (124) has moved into a grid tile area with a different preferred serving base station, a signal to the first UE (124) (e.g., request or command) triggering the first UE to perform cell reselection.

System Embodiment 4. The communications system of System Embodiment 3, wherein said first processor (1102) is further configured to operate the analytics server (110) to: send (925), in response to determining that the first UE (124) has moved into a grid tile area with a different preferred serving base station, a signal to the first UE (124) (e.g., request or command) triggering the first UE to perform cell reselection includes sending preferred base station information indicating the preferred serving base station for the grid tile area into which the first UE moved (e.g., indicate in signal to first UE that the first UE is to select BS A1 with PCI=21 as the new serving BS as part of the cell reselection process).

System Embodiment 4A. The communications system of System Embodiment 4, further comprising: said first UE (124) including a second processor (1602) configured to: operate the first UE (128) to perform (928) cell reselection while operating in idle mode with the indicated preferred serving base station (BS A1 with PCI=21) being selected as the new primary cell (e.g., without the UE performing signal measurements as part of the cell reselection operation).

System Embodiment 5. The communications system of System Embodiment 4, wherein said first processor (1102) is further configured to operate the analytics server to: receive (944), (e.g., at analytics server 110) from the first user device (124) location information via the indicated preferred base station (e.g., BS A1), said user device location information being communicated via the first base station while the first UE is in idle mode (e.g., without the first UE establishing an active RRC connection without the first base station (BS A1 116).

System Embodiment 6. The communications system (100) of System Embodiment 1, wherein said first processor (1102) is further configured to operate the analytics server (110) to: send (702, 704, 714) signals (e.g., from analytics server (110) to base stations (116, 118, 120)) to trigger UE signal measurements; and wherein the communications system (100) further includes: a performance management system (PMS) (114) including memory (1412) a second processor (1402) configured to operate the PMS 114 to: store (764, 774, 784, 794, 7954, 7959) (e.g., in database 1434 of memory 1414 of PMS 114) signal measurement report information indicating base station signal strength information measured by UEs at different geographic locations (e.g., reported received signal strength measurements and corresponding identifier of the base station to which an individual measurement corresponds is stored (e.g., UE reported signal measurement (received signal strength) and corresponding PCI is stored with different UEs reporting signal measurements made at different locations).

System Embodiment 7. The communications system of System Embodiment 6, further comprising: a server including a grid function (e.g., AI grid function 108) including a third processor (1202) configured to: process (811) stored reported signal measurement information including signal measurements made by UEs at different locations to generate said grid information.

System Embodiment 8. The communications system of System Embodiment 7, wherein said third processor (1202) is configured to: determine (812) one or more grid tile sizes for tiles of a grid for which said grid information is being determined; and determine (814) a geographic location for each tile of the grid for which grid information is being generated, as part of being configured to process (811) stored reported signal measurement information to generate said grid information.

System Embodiment 8A. The communications system of System Embodiment 8, wherein said third processor (1202) is configured to determine a single grid tile size or determine multiple different grid tile sizes, as part of being configured to determine one or more grid tile sizes.

System Embodiment 8B. The communications system of System Embodiment 8A, wherein the reported signal measurement information includes at least one signal measurement from the geographic area to which a grid tile corresponds (e.g., in some cases grid tiles are larger in size for areas for which fewer signal measurements are included in the stored measurement information and smaller for areas where larger number of signal measurements are included per unit area in the stored signal measurement information).

System Embodiment 9. The communications system of System Embodiment 8, wherein said third processor (1202) is configured to: select (816) a base station to be a preferred serving cell for each grid tile in the grid for which grid information is being generated, as part of being configured to process (811) stored reported signal measurement information including signal measurements made by UEs at different locations to generate said grid information.

System Embodiment 10. The communications system of System Embodiment 9, wherein the stored generated grid information is stored (in step 820) in a database (e.g., retrieved AI grid information 1148 in memory 1112 of analytics server 110 or AI grid database 1238) for use in making base station handoff or cell re-selection decisions (e.g., in a database accessible to an analytics server (110) or UEs 124, 126, etc.)).

System Embodiment 11. The communications system of System Embodiment 1, wherein said first processor (1102) is further configured to operate the analytics server (110) to: receive (958) a notification (e.g. at the analytics server 110) relating to a network event, alarm or outage; and trigger (972, 978, 984) measurements (e.g., send measurement messages 974, 980, 986 to base stations which in turn send measurement request messages 992, 998, 1004, 1010, 1016, 1024 to UEs) to collect information used to generate updated grid information.

System Embodiment 11A. The communications system of System Embodiment 11 wherein the received notification indicates a detected event, a received alarm or a detected outage of a network element (e.g. base station).

System Embodiment 11B. The communications system of System Embodiment 11A, wherein the detected event is expiration of a timer used to trigger a periodic grid update.

System Embodiment 12. The communications system of System Embodiment 11, wherein said first processor (1102) is further configured to operate the analytics server (110) to: receive (1080) notification that measurement information has been collected for updating grid information; and initiate (1081) a grid update (e.g., by sending a grid update request or command 1082 to an AI grid update function (108) following notification.

System Embodiment 13. The communications system of System Embodiment 12, further comprising: a server including a grid function (e.g., AI grid function 108) including a second processor (1202) configured to: operate the grid function (108) to update (1084) grid information based on measurement information collected from multiple UEs (124, 126, 128, 130, 132, 134).

The techniques of various embodiments may be implemented using software, hardware and/or a combination of software and hardware. Various embodiments are directed to apparatus, e.g., analytics servers, servers including an AI grid function, base stations, e.g. gNBs, user equipments (UEs), performance management system (PMS) devices, element management system (EMS) devices, access points (AP), e.g., WiFi APs supporting 802.11be and/or future versions, stations (STAs), e.g., WiFi STAs supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating analytics servers, servers including an AI grid function, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., analytics servers, servers including an AI grid function, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., analytics servers, servers including an AI grid function, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the analytics servers, servers including an AI grid function, base stations, e.g. gNBs, user equipments (UEs), performance management system (PMS) devices, element management system (EMS) devices, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., an analytics server, server including an AI grid function, base station, e.g. gNB, user equipment (UE), performance management system (PMS) device, element management system (EMS) device, access point (AP), e.g., WiFi AP, supporting 802.11be and/or future versions, station (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., analytics server, server including an AI grid function, base station, e.g. gNB, user equipment (UE), performance management system (PMS) device, element management system (EMS) device, access points (AP), e.g., WiFi AP, supporting 802.11be and/or future versions, stations (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an analytics server, server including an AI grid function, base station, e.g. gNB, user equipment (UE), performance management system (PMS) device, element management system (EMS) devices, an access point (AP), e.g., WiFi AP, supporting 802.11be and/or future versions, a stations (STA), e.g., a WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as an analytics server, server including an AI grid function, base station, e.g. gNB, user equipments (UE), performance management system (PMS) device, element management system (EMS) device, an access points (AP), e.g., a WiFi AP, supporting 802.11be and/or future versions, a station (STA), e.g., WiFi STA, supporting 802.11be and/or future versions, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of supporting communication using base stations, the method comprising:
storing grid information corresponding to a geographic area, said grid information including for each of a plurality of tiles of a grid corresponding to the geographic area: i) tile size information, ii) tile location information and iii) preferred serving cell information;
detecting movement of a first UE from a first grid tile area in which a first base station is a preferred base station to a second grid tile area;
determining from the stored grid information that a second base station, different from the first base station, is the preferred base station for the second grid tile; and
initiating a handover from the first base station to the second base station in response to determining that the second base station is the preferred base station for the grid tile area into which the first UE has moved.

2. The method of claim 1, wherein initiating a handover from the first base station to the second base station includes sending a handover signal to the first base station requesting or commanding the first base station to start a handover of the first UE to the second base station.

3. The method of claim 1, further comprising:
determining that the first UE, while operating in an idle mode of operation, has moved into a grid tile area with a different preferred serving base station than a serving base station being used by the first UE; and
sending, in response to determining that the first UE has moved into a grid tile area with a different preferred serving base station, a signal to the first UE triggering the first UE to perform cell reselection.

4. The method of claim 3, further comprising:
sending, in response to determining that the first UE has moved into a grid tile area with a different preferred serving base station, a signal to the first UE triggering the first UE to perform cell reselection includes sending preferred base station information indicating the preferred serving base station for the grid tile area into which the first UE moved.

5. The method of claim 4, further comprising:
receiving, from the first UE location information via the indicated preferred base station, said user device location information being communicated via the first base station while the first UE is in idle mode.

6. The method of claim 1, further comprising:
sending signals to trigger UE signal measurements; and
storing signal measurement report information indicating base station signal strength information measured by UEs at different geographic locations.

7. The method of claim 6, further comprising:
processing stored reported signal measurement information including signal measurements made by UEs at different locations to generate said grid information.

8. The method of claim 7, wherein said processing to generate said grid information includes:
determining one or more grid tile sizes for tiles of a grid for which said grid information is being determined; and
determining a geographic location for each tile of the grid for which grid information is being generated.

9. The method of claim 8, wherein processing stored reported signal measurement information including signal measurements made by UEs at different locations to generate said grid information further includes:
selecting a base station to be a preferred serving cell for each grid tile in the grid for which grid information is being generated.

10. The method of claim 1, further comprising:
receiving a notification relating to a network event, alarm or outage; and
triggering measurements to collect information used to generate updated grid information.

11. The method of claim 10, further comprising:
receiving notification that measurement information has been collected for updating grid information; and
initiating a grid update.

12. The method of claim 11, further comprising:
operating a grid function to update grid information based on measurement information collected from multiple UEs.

13. A communications system comprising:
a storage device for storing grid information corresponding to a geographic area, said grid information including for each of a plurality of tiles of a grid corresponding to the geographic area: i) tile size information, ii) tile location information and iii) preferred serving cell information;
an analytics server including a first processor configured to operate the analytics server to:
detect movement of a first UE from a first grid tile area in which a first base station is a preferred base station to a second grid tile area;
determine from the stored grid information that a second base station, different from the first base station, is the preferred base station for the second grid tile; and
initiate a handover from the first base station to the second base station in response to determining that the second base station is the preferred base station for the grid tile area into which the first UE has moved.

14. The communications system of claim 13, wherein said first processor is configured to operate the analytics server to:
send a handover signal to the first base station requesting or commanding the first base station to start a handover of the first UE to the second base station, as part of being configured to initiate a handover from the first base station to the second base station.

15. The communications system of claim 13, wherein said first processor is further configured to operate the analytics server to:
determine that the first UE, while operating in an idle mode of operation, has moved into a grid tile area with a different preferred serving base station than a serving base station being used by the first UE; and
send, in response to determining that the first UE has moved into a grid tile area with a different preferred serving base station, a signal to the first UE triggering the first UE to perform cell reselection.

16. The communications system of claim 15, wherein said first processor is further configured to operate the analytics server to:
send, in response to determining that the first UE has moved into a grid tile area with a different preferred serving base station, a signal to the first UE triggering the first UE to perform cell reselection includes sending preferred base station information indicating the preferred serving base station for the grid tile area into which the first UE moved.

17. The communications system of claim 16, wherein said first processor is further configured to operate the analytics server to:
receive, from the first user device location information via the indicated preferred base station, said user device location information being communicated via the first base station while the first UE is in idle mode.

18. The communications system of claim 13, wherein said first processor is further configured to operate the analytics server to:
send signals to trigger UE signal measurements; and wherein the communications system further includes:
a performance management system (PMS) including memory a second processor configured to operate the PMS to:
store signal measurement report information indicating base station signal strength information measured by UEs at different geographic locations.

19. The communications system of claim 18, further comprising: a server including a grid function including a third processor configured to:
process stored reported signal measurement information including signal measurements made by UEs at different locations to generate said grid information.

20. The communications system of claim 19, wherein said third processor is configured to:
determine one or more grid tile sizes for tiles of a grid for which said grid information is being determined; and
determine a geographic location for each tile of the grid for which grid information is being generated,
as part of being configured to process stored reported signal measurement information to generate said grid information.
